(19) United States
(12) Patent Application Publication
(10) Pub. No.: US 2026/0222831 A1
(43) Pub. Date: Jul. 30, 2026

(54) CAPABILITY REPORTING FOR DISTRIBUTED LANGUAGE MODEL PROCESSING

(71) Applicant: QUALCOMM Incorporated, San Diego, CA (US)

(72) Inventors: Hua WANG, Basking Ridge, NJ (US); Junyi LI, Greentown, PA (US); Karl Georg HAMPEL, Jersey City, NJ (US); Eren BALEVI, Brooklyn, NY (US); Tien Viet NGUYEN, Bridgewater, NJ (US)

(21) Appl. No.: 19/039,509

(22) Filed: Jan. 28, 2025

(51) Int. Cl. H04W 24/02

(52) U.S. Cl. CPC H04W 24/02

(57) ABSTRACT

Certain aspects of the present disclosure provide techniques for capability reporting associated distributed large language model (LLM) processing in a wireless communication system. An example method includes sending capability information that indicates one or more local computational capabilities associated with distributed computation of LLM data, wherein the capability information includes an indication of a subset of pretrained LLM layers that is accessible for local computation of the LLM data; obtaining an indication to report a status of at least one computational resource accessible for local computation of the LLM data; sending a first status report that includes an indication of first computational resource(s) available, for local computation of the LLM data, at a first occasion; and sending a second status report that includes an indication of second computational resource(s) available, for local computation of the LLM data, at a second occasion that occurs after the first occasion.

### INTRODUCTION

### Field of the Disclosure

Aspects of the present disclosure relate to wireless communications, and more particularly, to techniques for distributed language model processing in a wireless communication system.

### Description of Related Art

Wireless communications systems are widely deployed to provide various telecommunication services such as telephony, video, data, messaging, broadcasts, or other similar types of services. These wireless communications systems may employ multiple-access technologies capable of supporting communications with multiple users by sharing available wireless communications system resources with those users.

Although wireless communications systems have made great technological advancements over many years, challenges still exist. For example, complex and dynamic environments can still attenuate or block signals between wireless transmitters and wireless receivers. Accordingly, there is a continuous desire to improve the technical performance of wireless communications systems, including, for example: improving speed and data carrying capacity of communications, improving efficiency of the use of shared communications mediums, reducing power used by transmitters and receivers while performing communications, improving reliability of wireless communications, avoiding redundant transmissions and/or receptions and related processing, improving the coverage area of wireless communications, increasing the number and types of devices that can access wireless communications systems, increasing the ability for different types of devices to intercommunicate, increasing the number and type of wireless communications mediums available for use, and the like. Consequently, there exists a need for further improvements in wireless communications systems to overcome the aforementioned technical challenges and others.

### SUMMARY

Certain aspects provide a method for wireless communications by a user equipment (UE). The method includes sending capability information that indicates one or more local computational capabilities associated with distributed computation of large language model (LLM) data, wherein the capability information includes an indication of a subset of pretrained LLM layers that is accessible for local computation of the LLM data; obtaining an indication to report a status of at least one computational resource accessible for local computation of the LLM data; sending a first status report that includes an indication of one or more first computational resources available, for local computation of the LLM data, at a first occasion; and sending a second status report that includes an indication of one or more second computational resources available, for local computation of the LLM data, at a second occasion that occurs after the first occasion.

Certain aspects provide a method for wireless communications by a network node. The method includes obtaining capability information that indicates one or more local computational capabilities associated with distributed computation of LLM data, wherein the capability information includes an indication of a subset of pretrained LLM layers that is accessible for local computation of the LLM data; sending an indication to report a status of at least one computational resource accessible for local computation of the LLM data; obtaining a first status report that includes an indication of one or more first computational resources available, for local computation of the LLM data, at a first occasion; and obtaining a second status report that includes an indication of one or more second computational resources available, for local computation of the LLM data, at a second occasion that occurs after the first occasion.

Other aspects provide: one or more apparatuses operable, configured, or otherwise adapted to perform any portion of any method described herein (e.g., such that performance may be by only one apparatus or in a distributed fashion across multiple apparatuses); one or more non-transitory, computer-readable media comprising instructions that, when executed by one or more processors of one or more apparatuses, cause the one or more apparatuses to perform any portion of any method described herein (e.g., such that instructions may be included in only one computer-readable medium or in a distributed fashion across multiple computer-readable media, such that instructions may be executed by only one processor or by multiple processors in a distributed fashion, such that each apparatus of the one or more apparatuses may include one processor or multiple processors, and/or such that performance may be by only one apparatus or in a distributed fashion across multiple apparatuses); one or more computer program products embodied on one or more computer-readable storage media comprising code for performing any portion of any method described herein (e.g., such that code may be stored in only one computer-readable medium or across computer-readable media in a distributed fashion); and/or one or more apparatuses comprising one or more means for performing any portion of any method described herein (e.g., such that performance would be by only one apparatus or by multiple apparatuses in a distributed fashion). By way of example, an apparatus may comprise a processing system, a device with a processing system, or processing systems cooperating over one or more networks. An apparatus may comprise one or more memories; and one or more processors configured to cause the apparatus to perform any portion of any method described herein. In some examples, one or more of the processors may be preconfigured to perform various functions or operations described herein without requiring configuration by software.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1 depicts an example wireless communications network.

FIG. 2 depicts an example disaggregated base station architecture.

FIG. 3 depicts aspects of network entities and a user equipment (UE).

FIGS. 4A, 4B, 4C, and 4D depict various example aspects of data structures for a wireless communications network.

FIG. 5 illustrates an example artificial intelligence (AI) architecture that may be used for AI-enhanced wireless communications.

FIG. 6 illustrates an example AI architecture of a first wireless device that is in communication with a second wireless device.

FIG. 7 illustrates an example artificial neural network.

FIG. 8A depicts an example control plane protocol stack.

FIG. 8B depicts an example user plane protocol stack.

FIG. 9 depicts an example of large language model (LLM) segmentation for distributed LLM processing.

FIG. 10 depicts an example of distributed LLM processing via one or more edge devices.

FIG. 11 depicts an example computer architecture of an edge device.

FIG. 12A depicts a process flow for capability reporting for distributed language model processing.

FIG. 12B depicts another process flow for capability reporting for distributed language model processing.

FIG. 13 depicts a method for wireless communications.

FIG. 14 depicts another method for wireless communications.

FIG. 15 depicts aspects of an example communications device.

FIG. 16 depicts aspects of an example communications device.

### DETAILED DESCRIPTION

Aspects of the present disclosure provide apparatuses, methods, processing systems, and computer-readable mediums for capability reporting associated with distributed language model processing in a wireless communication system.

Large language models (LLMs) are becoming increasingly capable of performing various tasks, such as machine language translation, summarization, virtual assistance, searching, code development, or the like. An LLM may use a non-trivial amount of computational resources, such as memory and processing resources. As an example, a specific LLM (such as the third version of Large Language Model Meta artificial intelligence (Llama)) has 135 billion parameters and uses at least 320 gigabytes (GB) of video random access memory (VRAM) to run inference. As another example, the Generative Pre-trained Transformer 3 (GPT-3) model from OpenAI has 175 billion parameters and uses at least 400 GB of VRAM to run inference. In addition, LLMs and/or generative artificial intelligence (AI) are expected to be used in wireless communications systems. As an example, a transformer-based foundation model may be used in channel state information (CSI) estimation, CSI compression, beam management, or the like. As another example, LLM and/or generative AI may be used in digital twin applications to model a wireless environment, such as monitoring and configuring the operation of wireless systems, and or predict wireless communication activities.

Certain computational devices (such as edge devices including smartphones, tablets, laptop computers, desktop computers, extended reality headsets, video game consoles, Internet of Things (IoT) devices, vehicles, edge servers, or the like) may lack sufficient computational resources to run certain LLMs, such as certain Llama models, GPT-3, and/or future LLMs. In the context of LLM inference, an edge device may refer to a device that is at or adjacent to the edge of a wireless communications system, such as an edge user device (for example, including a UE) and/or an edge server device (for example, including a network node and/or an application server). An edge device may provide access to an LLM service. To enable inference processing on such edge devices, one option may be to run a smaller LLM on these devices, such as an LLM having 1 billion parameters (an example of a sub-10 billion parameter model). However, sub-10 billion parameters models may be less accurate in terms of inference performance compared to other larger LLMs, as described above.

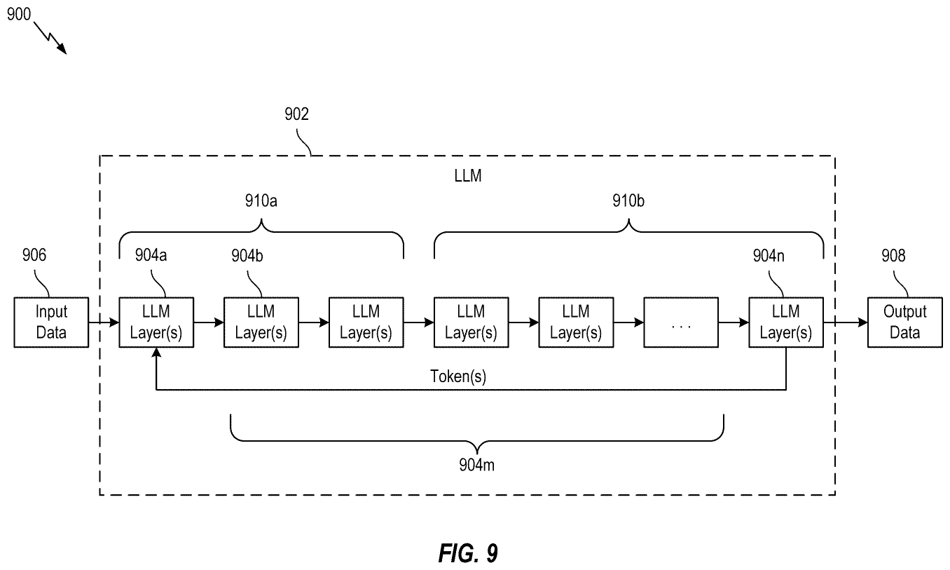

Another option may be to perform distributed LLM processing (or distributed LLM inference) across multiple computational devices (such as one or more edge devices). Under distributed LLM processing, the LLM model may be divided into segments or subset(s) of LLM layers as further described herein with respect to FIG. 9. The different LLM segments (or subsets) may be deployed to different computational devices (such as one or more edge devices). Then, LLM processing may be shared among the computational devices with small amounts of LLM data exchanged between the devices. In certain cases, a model server may schedule certain LLM processing tasks at the computational devices.

Technical problems for distributed LLM processing may include, for example, effective scheduling of LLM processing task(s) at a specific computational device, such as a UE or edge device. As the UE may be perform various tasks over time (such as LLM processing, video streaming, gaming, voice or video communications, or the like), the computational resources available for local computation of LLM data (for example, data processed as part of distributed LLM processing) at the UE may change over time. Even in cases where the UE has computational resources dedicated to LLM processing (such as an AI processor), the computational resources available for local computation at a particular time may depend on the implementation of the LLM and the stage of inference. As an example, Paged Attention is a specific algorithm that manages the cache of key and value vectors (e.g., KV cache) for LLM processing. Under Paged Attention, the memory usage may change over time and depend on the current context length of the LLM. However, it may not be established how to report the computational capabilities and/or status of computational resources associated with a UE for distributed LLM processing. Thus, in certain cases, a network node (and/or model server) may be unaware of the computational capabilities and/or status of computational resources associated with a UE to make distributed LLM processing decisions, such as scheduling of LLM processing tasks for distributed inference.

Aspects described herein may overcome the aforementioned technical problem(s), for example, by providing techniques for reporting certain information associated with distributed LLM processing, such as computational capabilities and/or the status of computational resources. Such reporting techniques may ensure that a network node and/or model server has up-to-date information to manage LLM processing tasks at a particular UE, such as scheduling LLM processing tasks. In certain aspects, a UE may report its computational capabilities to perform distributed LLM processing, such as report an indication of a subset of LLM layers supported for distributed LLM processing at the UE. In certain aspects, the UE may periodically report the status of computational resources available for distributed LLM processing. In certain aspects, the UE may be configured with certain trigger event(s) that, upon being satisfied, trigger the UE to report the status of computational resources.

Certain techniques for reporting information associated with distributed LLM processing described herein may provide various beneficial technical effects and/or advantages. The techniques for reporting information associated with distributed LLM processing may enable reduced latencies in processing LLM data and/or enable reliable and accurate generation of LLM data (e.g., any LLM generated content). The reduced latencies may be attributable to the reporting techniques ensuring that a network node and/or model server has up-to-date information associated with the computational resources of a UE to make distributed LLM processing decisions. As an example, a UE may report, to a network node, the status of the computational resources available for distributed LLM processing. Based on the reported status, the network node may determine which LLM processing tasks, if any, to schedule at the UE, for example, without or with reduced errors (such as overscheduling or scheduling incompatibilities) in scheduling LLM processing tasks.

The improved reliability and/or accuracy of LLM data may be attributable to using LLMs with certain reliability and/or accuracy specifications, for example, due to the distributed LLM processing enabled through the reporting techniques. As an example, the reporting techniques described herein may enable the use of LLMs with a large number of parameters (e.g., greater than or equal to 10 billion parameters) compared to smaller LLMs (e.g., less than 10 billion parameters, sub-10 billion parameter models, or the like). Thus, the LLMs used for distributed LLM processing may generate LLM data with improved reliability and/or accuracy.

### Introduction to Wireless Communications Networks

The techniques and methods described herein may be used for various wireless communications networks. While aspects may be described herein using terminology commonly associated with 3G, 4G, 5G, 6G, and/or other generations of wireless technologies, aspects of the present disclosure may likewise be applicable to other communications systems and standards not explicitly mentioned herein.

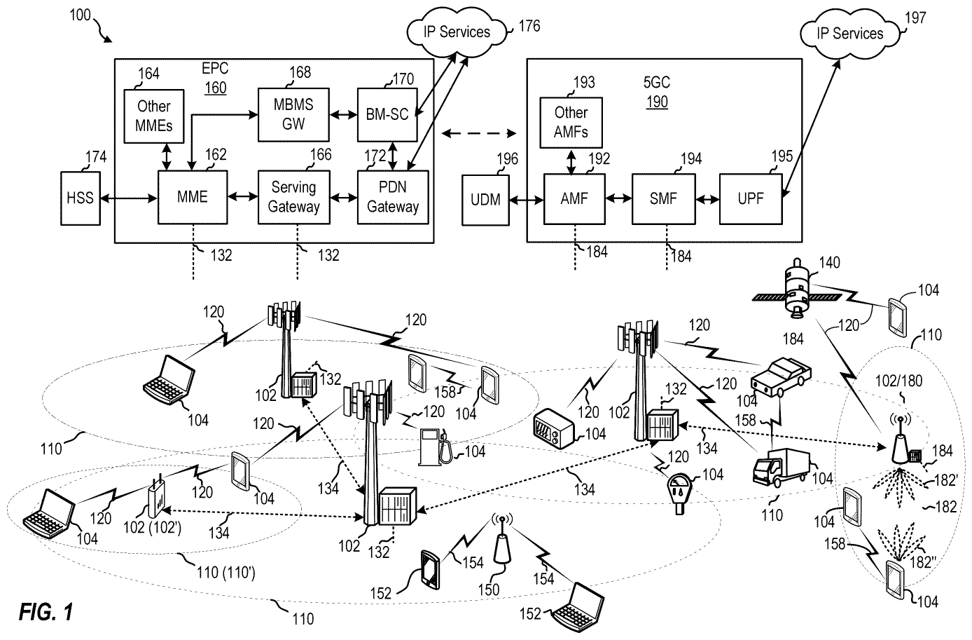

FIG. 1 depicts an example of a wireless communications network 100, in which aspects described herein may be implemented.

Generally, wireless communications network 100 includes various network entities (alternatively, network elements or network nodes). A network entity is generally a communications device and/or a communications function performed by a communications device (e.g., a user equipment (UE), a base station (BS), a component of a BS, a server, etc.). As such communications devices are part of wireless communications network 100, and facilitate wireless communications, such communications devices may be referred to as wireless communications devices. For example, various functions of a network as well as various devices associated with and interacting with a network may be considered network entities. Further, wireless communications network 100 may include terrestrial aspects, such as ground-based network entities (e.g., BSs 102), and non-terrestrial aspects (also referred to herein as non-terrestrial network entities). A non-terrestrial network entity may include satellite 140, which may be an example of an aerial or space-borne platform. In some examples, satellite 140 may include one or more network entities on-board (e.g., one or more BSs) capable of communicating with other network elements (e.g., terrestrial BSs) and UEs. For example, satellite 140 may be implemented according to a regenerative architecture (also referred to as a non-transparent architecture), and a gNB implemented at satellite 140 may implement higher-layer network functions. As another example, satellite 140 may be implemented according to a transparent architecture, and may perform a physical or other lower-layer repeater function for UEs and a network entity (such as a gateway associated with the satellite 140).

In the depicted example, wireless communications network 100 includes BSs 102, UEs 104, and one or more core networks, such as an Evolved Packet Core (EPC) 160 or a 5G Core (5GC) network 190, which interoperate to provide communications services over various communications links, including wired and wireless links. In some aspects, a core network, such as a 6G core, may implement a converged service-based architecture. In a converged service-based architecture, functions traditionally split between a core network (such as 5GC network 190) and a radio access network (RAN) (such as BS 102) may be implemented at a single network entity. For example, a mobility network entity may perform both core network functions and RAN functions related to mobility of UEs 104 attached to the wireless communications network 100. “Network entity” can refer to a BS 102, a network entity of EPC 160 or 5GC network 190, or a network entity of a converged service-based architecture.

FIG. 1 depicts various example UEs 104. UE 104 may include a cellular phone, a smart phone, a session initiation protocol (SIP) phone, a laptop, a personal digital assistant (PDA), a satellite radio, a Global Positioning System device, a multimedia device, a video device, a digital audio player, a camera, a game console, a tablet, a smart device, a wearable device, a vehicle, an electric meter, a gas pump, a kitchen appliance, a healthcare device, an implant, a sensor/actuator, a display, an Internet of Things (IoT) device, an always on (AON) device, an edge processing device, a data center, or another similar device. A UE 104 may also be referred to as a mobile device, a wireless device, a station, a mobile station, a subscriber station, a mobile subscriber station, a mobile unit, a subscriber unit, a wireless unit, a remote unit, a remote device, an access terminal, a mobile terminal, a wireless terminal, a remote terminal, a handset, and others.

BSs 102 wirelessly communicate with (e.g., transmit signals to or receive signals from) UEs 104 via communications links 120. A communications link 120 between a BS 102 and a UE 104 may include uplink (UL) (also referred to as reverse link) transmissions from a UE 104 to a BS 102 and/or downlink (DL) (also referred to as forward link) transmissions from a BS 102 to a UE 104. A communications link 120 may use multiple-input and multiple-output (MIMO) antenna technology, including spatial multiplexing, beamforming, and/or transmit diversity in various aspects.

A BS 102 may include a NodeB, an enhanced NodeB (eNB), a next generation enhanced NodeB (ng-eNB), a next generation NodeB (gNB or gNodeB), an access point, a base transceiver station, a radio base station, a radio transceiver, a transceiver function, a transmission reception point (TRP), a radio unit (RU), a distributed unit (DU), or the like. A given BS 102 may provide communications coverage for a coverage area 110, which may sometimes be referred to as a cell, and which may overlap another coverage area 110 (e.g., a small cell provided by a BS 102′) may have a coverage area 110′ that overlaps the coverage area 110 of a macro cell). A BS 102 may, for example, provide communications coverage for a macro cell (covering a relatively large geographic area), a pico cell (covering a relatively smaller geographic area, such as a sports stadium), a femto cell (covering a relatively smaller geographic area, such as a home), or another type of cell.

The term “cell” may refer to a portion, partition, or segment of wireless communication coverage served by a network entity within a wireless communications network 100. A cell may have geographic characteristics, such as a geographic coverage area, as well as radio frequency characteristics, such as time and/or frequency resources dedicated to the cell. For example, a specific geographic coverage area may be covered by multiple cells employing different frequency resources (e.g., bandwidth parts) and/or different time resources. As another example, a specific geographic coverage area may be covered by a single cell. In some contexts (e.g., a carrier aggregation scenario and/or multi-connectivity scenario), the terms “cell” or “serving cell” may refer to or correspond to a specific carrier frequency (e.g., a component carrier) used for wireless communications, and a “cell group” may refer to or correspond to multiple carriers used for wireless communications. As examples, in a carrier aggregation scenario, a UE may communicate on multiple component carriers corresponding to multiple (serving) cells in the same cell group, and in a multi-connectivity (e.g., dual connectivity) scenario, a UE may communicate on multiple component carriers corresponding to multiple cell groups.

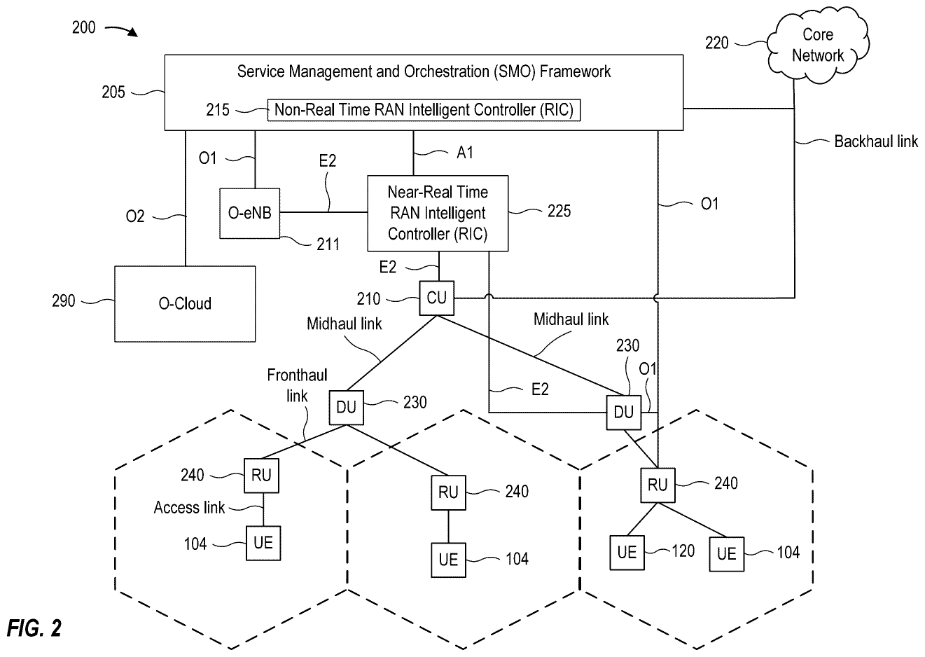

While BSs 102 are depicted in various aspects as unitary communications devices, BSs 102 may be implemented in various configurations. For example, one or more components of a base station may be disaggregated, including a central unit (CU), one or more DUs, one or more RUs, a Near-Real Time (Near-RT) RAN Intelligent Controller (RIC), or a Non-Real Time (Non-RT) RIC, to name a few examples. In another example, various aspects of a base station may be virtualized. A base station (e.g., BS 102) may include components that are located at a single physical location or components located at various physical locations. In examples in which a base station includes components that are located at various physical locations, the various components may each perform functions such that, collectively, the various components achieve functionality that is similar to a base station that is located at a single physical location. Implementing a base station in this fashion may provide efficiency gains by enabling cloud-based implementation of certain (e.g., non-time-sensitive) higher-layer functions while physical-layer or other lower-layer functions can be implemented at or in proximity to a geographic coverage area of a corresponding cell. In some aspects, a base station including components that are located at various physical locations may be referred to as having a disaggregated RAN architecture, such as an Open RAN (O-RAN) or Virtualized RAN (VRAN) architecture. FIG. 2 depicts and describes an example disaggregated RAN architecture.

Different BSs 102 within wireless communications network 100 may also be configured to support different radio access technologies, such as 3G, 4G, 5G, and/or 6G. For example, BSs 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an S1 interface). BSs 102 configured for 5G (e.g., 5G NR or Next Generation RAN (NG-RAN)) may interface with 5 GC 190 through second backhaul links 184. BSs 102 may communicate directly or indirectly (e.g., through the EPC 160 or the 5GC 190) with each other over third backhaul links 134 (e.g., an X2 or XN interface), which may be wired or wireless.

Wireless communications network 100 may subdivide the electromagnetic spectrum into various classes, bands, channels, or other features. In some aspects, the subdivision is provided based on wavelength and frequency, where frequency may also be referred to as a carrier, a subcarrier, a frequency channel, a tone, or a subband. For example, the Third Generation Partnership Project (3GPP) currently defines Frequency Range 1(FR 1 ) as including 410 MHz-7125 MHz, which is often referred to (interchangeably) as “Sub- 6 GHz”. Similarly, 3GPP currently defines Frequency Range 2(FR 2 ) as including 24,250 MHz-71,000 MHz, which is sometimes referred to (interchangeably) as a “millimeter wave” (“mmW” or “mmWave”). In some cases, FR2 may be further defined in terms of sub-ranges, such as a first sub-range FR2-1 including 24,250 MHz-52,600 MHz and a second sub-range FR2 -2 including 52,600 MHz-71,000 MHz. A base station configured to communicate using mmWave/near mmWave radio frequency bands (e.g., a mmWave base station such as BS 180) may utilize beamforming (e.g., 182) with a UE (e.g., 104) to improve path loss and range.

A communications links 120 may be through one or more carriers, which may have different bandwidths (e.g., 5 MHz, 10 MHz, 15 MHz, 20 MHz, 100 MHz, 400 MHz, and/or other bandwidths), and which may be aggregated in various aspects. Carriers may or may not be adjacent to each other. Allocation of carriers may be asymmetric with respect to DL and UL (e.g., more or fewer carriers may be allocated for DL than for UL).

Communications using higher frequency bands may have higher path loss and a shorter range compared to lower frequency communications. Accordingly, certain base stations (e.g., base station 180 in FIG. 1) may utilize beamforming (indicated by reference number 182) with a UE 104 to improve path loss and range. For example, BS 180 and the UE 104 may each include a plurality of antennas, such as antenna elements, antenna panels, and/or antenna arrays to facilitate the beamforming. In some cases, BS 180 may transmit a beamformed signal to UE 104 in one or more transmit directions 182′. UE 104 may receive the beamformed signal from the BS 180 in one or more receive directions 182″. UE 104 may also transmit a beamformed signal to the BS 180 in one or more transmit directions 182″. BS 180 may also receive the beamformed signal from UE 104 in one or more receive directions 182′. BS 180 and UE 104 may perform beam training to determine suitable receive and transmit directions for each of BS 180 and UE 104. Notably, the transmit and receive directions for BS 180 may or may not be the same. Similarly, the transmit and receive directions for UE 104 may or may not be the same.

Wireless communications network 100 may include a Wi-Fi access point (AP) 150 in communication with Wi-Fi stations (STAs) 152 via communications links 154 in, for example, a 2.4 GHz and/or 5 GHz unlicensed frequency spectrum.

Certain UEs 104 may communicate with each other using device-to-device (D2D) communications link 158. In some examples, D2D communications link 158 may use one or more sidelink channels, such as a physical sidelink broadcast channel (PSBCH), a physical sidelink discovery channel (PSDCH), a physical sidelink shared channel (PSSCH), a physical sidelink control channel (PSCCH), and/or a physical sidelink feedback channel (PSFCH). D2D communications link 158 may be implemented using a variety of technologies, such as a radio access technology (e.g., 5G, ProSe sidelink), a WiFi technology, a Bluetooth technology, or the like.

EPC 160 may include various functional components, such as a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and/or a Packet Data Network (PDN) Gateway 172. MME 162 may be in communication with a Home Subscriber Server (HSS) 174. MME 162 is a control node that processes signaling between the UEs 104 and the EPC 160. Generally, MME 162 provides bearer and connection management.

Generally, user Internet protocol (IP) packets are transferred through Serving Gateway 166. Serving gateway 166 is connected to PDN Gateway 172. PDN Gateway 172 provides UE IP address allocation as well as other functions. PDN Gateway 172 and BM-SC 170 are connected to IP Services 176, which may include, for example, the Internet, an intranet, an IP Multimedia Subsystem (IMS), a Packet Switched (PS) streaming service, and/or other IP services.

BM-SC 170 may provide functions for MBMS user service provisioning and delivery. BM-SC 170 may serve as an entry point for content provider MBMS transmission, may be used to authorize and initiate MBMS Bearer Services within a public land mobile network (PLMN), and/or may be used to schedule MBMS transmissions. MBMS Gateway 168 may be used to distribute MBMS traffic to the BSs 102 belonging to a Multicast Broadcast Single Frequency Network (MBSFN) area broadcasting a particular service, and/or may be responsible for session management (start/stop) and for collecting eMBMS related charging information.

5GC 190 may include various functional components, such as an Access and Mobility Management Function (AMF) 192, other AMFs 193, a Session Management Function (SMF) 194, and a User Plane Function (UPF) 195. AMF 192 may be in communication with Unified Data Management (UDM) 196.

AMF 192 is a control node that processes signaling between UEs 104 and the 5GC 190. AMF 192 provides, for example, quality of service (QoS) flow and session management.

IP packets are transferred through UPF 195, which is connected to the IP Services 197. UPF 195 may provide UE IP address allocation as well as other functions for 5GC 190. IP Services 197 may include, for example, the Internet, an intranet, an IMS, a PS streaming service, and/or other IP services.

In various aspects, a network entity or network node can be implemented as an aggregated base station, as a disaggregated base station, a component of a base station, an integrated access and backhaul (IAB) node, a relay node, a core network entity, or a sidelink node, to name a few examples.

FIG. 2 depicts an example disaggregated base station 200 architecture. The disaggregated base station 200 architecture may include one or more CUs 210 that can communicate directly with a core network 220 or other CUs 210 via a backhaul link (such as backhaul link 134), or indirectly with the core network 220 through one or more disaggregated base station units (such as a Near-Real Time (Near-RT) RAN Intelligent Controller (RIC) 225 via an E2 link, a Non-Real Time (Non-RT) RIC 215 associated with a Service Management and Orchestration (SMO) Framework 205, or both). A CU 210 may communicate with one or more DUs 230 via respective midhaul links, such as an F1 interface. The DUs 230 may communicate with one or more RUs 240 via respective fronthaul links. The RUs 240 may communicate with respective UEs 104 via one or more radio frequency (RF) access links (such as communication link 120). In some implementations, a UE 104 may be simultaneously served by multiple RUs 240.

Each of the units, e.g., the CUs 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or a processor or controller providing instructions to the interfaces of the units, can be configured to communicate with one or more of the other units via the transmission medium. For example, the units can include a wired interface configured to receive or transmit signals over a wired transmission medium to one or more of the other units. Additionally or alternatively, the units can include a wireless interface, which may include a receiver, a transmitter, or a transceiver (such as a RF transceiver), configured to receive or transmit signals, or both, over a wireless transmission medium.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (e.g., Central Unit - User Plane (CU-UP)), control plane functionality (e.g., Central Unit—Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the E1 interface when implemented in an O-RAN configuration. The CU 210 can be implemented to communicate with the DU 230 for network control and signaling.

The DU 230 may be or correspond to a logical unit that includes one or more base station functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3^{rd} Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communications with one or more UEs 104. In some implementations, real-time and non-real-time aspects of control and user plane communications with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, RUs 240 and Near-RT RICs 225. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more DUs 230 and/or one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via O1) or via creation of RAN management policies (such as A1 policies).

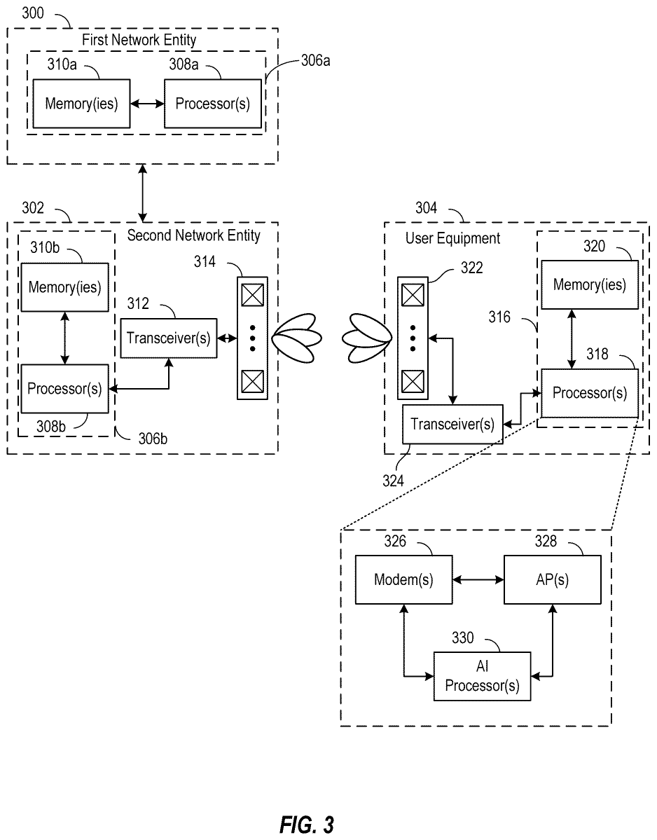

FIG. 3 depicts aspects of network entities 300 and 302 and a UE 304.

FIG. 3 includes a first network entity 300 and a second network entity 302. In some examples, first network entity 300 may be an example of a CU 210 or a DU 230. In some examples, second network entity 302 may be an example of a DU 230 or an RU 240. First network entity 300 and second network entity 302 may communicate with one another via a communications link, such as a midhaul link. In some examples, first network entity 300 and second network entity 302 may be implemented at a same BS (e.g., BS 102). For example, first network entity 300 and second network entity 302 may be co-located. In some other examples, first network entity 300 may be implemented separately from second network entity 302. For example, first network entity 300 may be implemented as a function (e.g., one or more processes) running on a server, such as in a cloud (e.g., a public or private cloud). As another example, first network entity 300 may be implemented as a virtual computing instance (e.g., virtual machine, container, etc.) or as a physical server.

First network entity 300 and second network entity 302 each include a processing system 306, illustrated as “processing system 306a” at first network entity 300 and “processing system 306b” at second network entity 302. For example, first network entity 300 and second network entity 302 may include one or more chips, system-on-chips (SoCs), system-in-packages (SiPs), chipsets, packages, or devices that individually or collectively constitute or comprise a processing system 306. A processing system 306 includes one or more processors 308 (illustrated as “processor(s) 308a” and “processor(s) 308b”) and one or more memories 310 (illustrated as “memory(ies) 310a” and “memory(ies) 310b”) coupled to the one or more processors 308. The one or more processors 308 may include one or multiple processors, microprocessors, processing units (such as central processing units (CPUs), graphics processing units (GPUs), neural processing units (NPUs) (also referred to as neural network processors or deep learning processors (DLPs)) and/or digital signal processors (DSPs)), processing blocks, application-specific integrated circuits (ASIC), programmable logic devices (PLDs) (such as field programmable gate arrays (FPGAs)), or other discrete gate or transistor logic or circuitry (any one or more of which may be generally referred to herein individually as a “processor” or collectively as “the processor” or “the processor circuitry”). One or more of the processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

In some aspects, the processing system 306 may perform processing (such as digital signal processing) of data, control information, or signals received or transmitted by a network entity. For example, the processing system 306 may include a coder, a decoder, a multiplexer, a demultiplexer, a transmit MIMO processor, a transmit processor, a receive processor, a receive MIMO detector, an automatic gain control component, or the like.

The one or more memories 310 may include one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). The one or more memories 310 may store data and program code for first network entity 300 and/or second network entity 302.

As further shown, second network entity 302 includes one or more transceivers 312 (illustrated as “transceiver(s) 312”). The one or more transceivers 312 may perform processing related to implementing physical layer (e.g., radio, air interface) communication with other devices such as UE 304. The one or more transceivers 312 may include one or more radio frequency (RF) components, such as an RF transceiver, a front-end module (e.g., an RF front-end (RFFE)), or the like. For example, the one or more transceivers 312 may include a transmit path (also referred to as a transmit chain), a receive path (also referred to as a receive chain), and/or an interface with one or more antennas 314.

The one or more antennas 314 may perform wireless transmission and reception of signals. The one or more antennas 314 may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled with one or more transmission or reception components, such as one or more components of FIG. 3.

UE 304 may be an example of UE 104. As shown, UE 304 includes a processing system 316. For example, UE 304 may include one or more chips, SoCs, SiPs, chipsets, packages, or devices that individually or collectively constitute or comprise a processing system 316. A processing system 316 includes one or more processors 318, and one or more memories 320 coupled to the one or more processors 318. Further, UE 304 includes one or more antennas 322, one or more transceivers 324, and/or other components that enable wireless transmission and reception of data.

The one or more processors 318 may include one or multiple processors, microprocessors, processing units (such as CPUs, GPUs, NPUs (also referred to as neural network processors or DLPs) and/or DSPs), processing blocks, ASICs, PLDs (such as FPGAs), or other discrete gate or transistor logic or circuitry (any one or more of which may be generally referred to herein individually as a “processor” or collectively as “the processor” or “the processor circuitry”). One or more of the processors may be individually or collectively configurable or configured to perform various functions or operations described herein. In some aspects, the processing system 316 may perform processing (such as digital signal processing) of data, control information, or signals received or transmitted by a network entity. For example, the processing system 316 may include a coder, a decoder, a multiplexer, a demultiplexer, a transmit MIMO processor, a transmit processor, a receive processor, a receive MIMO detector, an automatic gain control component, or the like.

As shown, in some examples, the one or more processors 318 may include one or more modems 326, one or more application processors (APs) 328, one or more AI processors 330, a combination thereof, and/or another form of processor.

The one or more modems 326 may include a digital signal processor that converts information into a waveform for analog signal transmission (e.g., via modulation) and/or converts the waveform of a received signal into information (e.g., via demodulation). The one or more modems 326 may process information or waveforms in connection with signal transmission or reception. For example, the one or more modems 326 may include a coder, a decoder, a multiplexer, a demultiplexer, a transmit MIMO processor, a transmit processor, a receive processor, a receive MIMO detector, an automatic gain control component, or the like.

The one or more APs 328 may perform processing relating to an operating system and/or a higher layer application of the UE 304. For example, the one or more APs 328 may provide a higher-level operating system (HLOS), software, audio or video processing, graphics processing, or the like. In some examples, the one or more APs 328 may be a data source (e.g., for transmissions) or a data sink (e.g., for receptions).

The one or more transceivers 324 may perform processing related to implementing physical layer (e.g., radio, air interface) communication with other devices such as other UEs 304 or second network entity 302. The one or more transceivers 324 may include one or more RF components, such as an RF transceiver, a front-end module (e.g., an RFFE), or the like. For example, the one or more transceivers 324 may include a transmit path (also referred to as a transmit chain), a receive path (also referred to as a receive chain), and/or an interface with one or more antennas 322.

The one or more antennas 322 may perform wireless transmission and reception of signals. The one or more antennas 322 may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled with one or more transmission or reception components, such as one or more components of FIG. 3.

For an example downlink transmission by second network entity 302, the processing system 306 (e.g., a transmit processor) may receive data and/or control information. The control information may be for the physical broadcast channel (PBCH), physical control format indicator channel (PCFICH), physical hybrid automatic repeat request (HARQ) indicator channel (PHICH), physical downlink control channel (PDCCH), group common PDCCH (GC PDCCH), and/or others. The data may be for the physical downlink shared channel (PDSCH), in some examples.

The processing system 306 (e.g., a transmit processor) may process (e.g., encode and symbol map) the data and control information to obtain data symbols and control symbols, respectively. The processing system 306 may also generate reference symbols, such as for the primary synchronization signal (PSS), secondary synchronization signal (SSS), PBCH demodulation reference signal (DMRS), or channel state information reference signal (CSI-RS).

The processing system 306 (e.g., a TX MIMO processor) may perform spatial processing (e.g., precoding) on the data symbols, the control symbols, and/or the reference symbols, if applicable, and may provide output symbol streams to one or more modulators of the processing system 306. The one or more modulators may process one or more respective output symbol streams to obtain an output sample stream. The one or more transceivers 312 may process (e.g., convert to analog, amplify, filter, and upconvert) the output sample stream to obtain a downlink signal. Second network entity 302 may transmit the downlink signal via the one or more antennas 314.

In order to receive the downlink transmission at UE 304 (or a sidelink transmission from another UE), the one or more antennas 322 may receive the downlink signal and may provide received signals to the one or more transceivers 324. The one or more transceivers 324 may condition (e.g., filter, amplify, downconvert, and digitize) the received signals to obtain input samples. The one or more transceivers 324 and/or the processing system 316 may further process the input samples to obtain received symbols.

The processing system 316 (e.g., modem 326, an RX MIMO detector) may obtain the received symbols, perform MIMO detection on the received symbols if applicable, and provide detected symbols. The processing system 316 (e.g., a modem 326, a receive processor) may process (e.g., de-interleave and decode) the detected symbols. The processing system 316 may provide decoded data for the UE 304 (e.g., to an AP 328) and/or decoded control information (e.g., to a controller/processor of the processing system 316).

For an example uplink transmission or a sidelink transmission from UE 304, the processing system 316 (e.g., modem 326, a transmit processor) may receive and process data and/or control information to obtain a set of symbols for transmission. The data may be for the physical uplink shared channel (PUSCH), and may be received from a data source such as the AP 328. The control information may be for the physical uplink control channel (PUCCH), and may be received, for example, from a controller/processor of the processing system 316. The processing system 316 (e.g., a modem 326, the transmit processor) may also generate reference symbols for a reference signal (e.g., for a sounding reference signal (SRS), a demodulation reference signal, a phase tracking reference signal, or the like). In some examples, the symbols and/or reference signals may be precoded by the processing system 316 (e.g., modem 326, a TX MIMO processor), further processed by the one or more transceivers 324 (e.g., for SC-FDM), and transmitted to second network entity 302.

At second network entity 302, the uplink signals from UE 304 may be received by the one or more antennas 314, conditioned by the one or more transceivers 312 (e.g., filtered, amplified, downconverted, and digitized), detected (e.g., by the processing system 306b such as a modem and/or an RX MIMO detector), and further processed by the processing system 306b (e.g., a modem and/or a receive processor) to obtain decoded data and control information sent by UE 304. The processing system 306b may provide the decoded data and the decoded control information (such as to a controller/processor of the processing system 306b, an AP, first network entity 300, or another entity).

In various aspects, a wireless communication device, such as first network entity 300, second network entity 302, BS 102, UE 104, or UE 304 may be described as sending, transmitting, obtaining, or receiving various types of data associated with the methods described herein. In these contexts, “transmitting” or “sending” may refer to various mechanisms of outputting data, such as outputting data from a processing system, one or more memories, one or more transceivers, one or more antennas, and/or other aspects described herein. For example, “sending” or “transmitting” by a device may include sending (such as wirelessly, via a wired connection, or both) to a recipient directly or via another device. As another example, “sending” or “transmitting” may include sending internally to a device (such as the UE 304, first network entity 300, or second network entity 302) by a process to memory. “Receiving” or “obtaining” may refer to various mechanisms of obtaining data, such as obtaining data from the processing system, one or more memories, one or more transceivers, one or more antennas, and/or other aspects described herein. For example, “receiving” or “obtaining” by a device may include obtaining (such as wirelessly, via a wired connection, or both) from a recipient directly or via another device. As another example, “receiving” or “obtaining” may include obtaining internally to a device (such as the UE 304, first network entity 300, or second network entity 302) by a process from memory. As used herein, “communicating” by a device may include sending, obtaining, receiving, and/or transmitting a communication. “Communicating” can refer to communication with another device or internal communication of the device.

In various aspects, the processing system 306 or the processing system 316 may include one or more AI processors (such as AI processor 330 of the processing system 316). An AI processor may perform AI processing. The AI processor may include AI accelerator hardware or circuitry such as one or more neural processing units (NPUs), one or more neural network processors, one or more tensor processors, one or more deep learning processors, etc. As an example, the AI processor may perform AI-based beam management, AI-based channel state feedback (CSF), AI-based antenna tuning, and/or AI-based positioning (e.g., non-line of sight positioning prediction). In some cases, at the UE 104, the AI processor may process feedback generated by the UE 304 (e.g., CSF) using hardware accelerated AI inferences and/or AI training. In some cases, at the second network entity 302, the AI processor may decode compressed CSF from the UE 304, for example, using a hardware accelerated AI inference associated with the CSF. In certain cases, the AI processor may perform certain RAN-based functions including, for example, network planning, network performance management, energy-efficient network operations, etc.

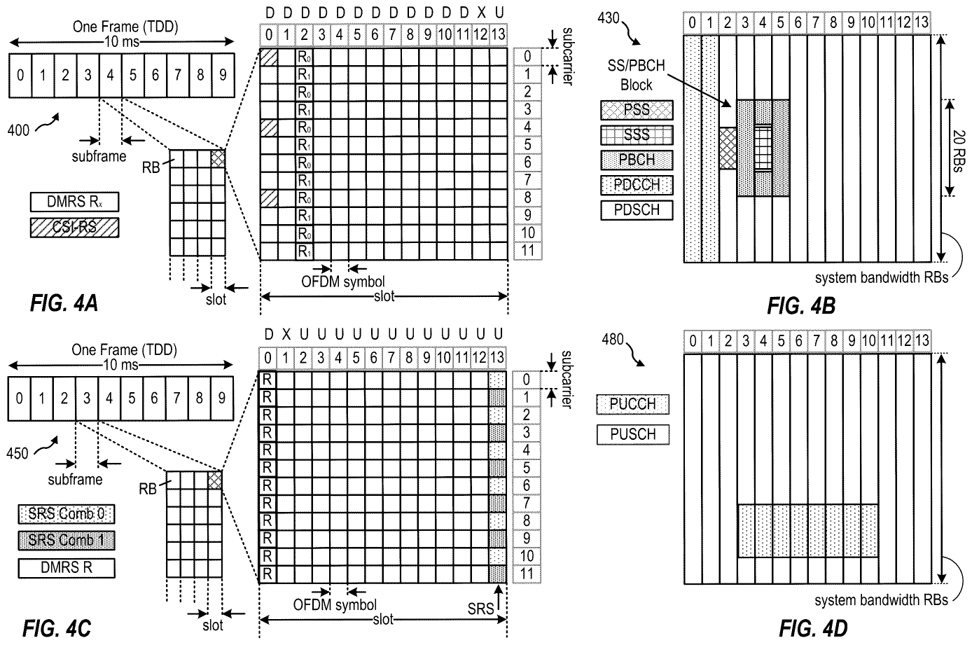

FIGS. 4A, 4B, 4C, and 4D depict aspects of data structures for a wireless communications network, such as wireless communications network 100 of FIG. 1.

FIG. 4A is a diagram 400 illustrating an example of a first subframe within a 5G (e.g., 5G NR) frame structure, FIG. 4B is a diagram 430 illustrating an example of DL channels within a 5G subframe, FIG. 4C is a diagram 450 illustrating an example of a second subframe within a 5G frame structure, and FIG. 4D is a diagram 480 illustrating an example of UL channels within a 5G subframe.

Wireless communications systems may utilize orthogonal frequency division multiplexing (OFDM) with a cyclic prefix (CP) on the uplink and downlink. Such systems may also support half-duplex operation using time division duplexing (TDD). OFDM and single-carrier frequency division multiplexing (SC-FDM) partition the system bandwidth (e.g., as depicted in FIGS. 4B and 4D) into multiple orthogonal subcarriers. One or more subcarriers may be modulated with data. Modulation symbols may be sent in the frequency domain with OFDM and/or in the time domain with SC-FDM.

In some examples, a wireless communications frame structure may be implemented using frequency division duplexing (FDD). In FDD, some subcarriers may be configured for DL communication, and other subcarriers (which may overlap in time with the DL subcarriers) may be configured for UL communication. In some other examples, wireless communications frame structures may be implemented using time division duplexing (TDD). In TDD, for a particular set of subcarriers, some subframes are configured for DL communication and other subframes are configured for UL communication.

In FIGS. 4A and 4C, the wireless communications frame structure is implemented using TDD. “D” indicates DL time resources, “U” indicates UL time resources, and “X” indicates flexible time resources for use or later reconfiguration for either DL or UL communication. UEs may be configured with a slot format through a received slot format indicator (SFI) (dynamically through DL control information (DCI), or semi-statically/statically through radio resource control (RRC) signaling). In the depicted examples, a 10 ms frame is divided into 10 equally sized 1 ms subframes. Each subframe may include one or more time slots. In some examples, each slot may include 12 or 14 symbols, depending on the cyclic prefix (CP) type (e.g., 12 symbols per slot for an extended CP or 14 symbols per slot for a normal CP). Subframes may also include mini-slots, which generally have fewer symbols than an entire slot. Other wireless communications technologies may have a different frame structure and/or different channels.

In certain aspects, the number of slots within a subframe (e.g., a slot duration in a subframe) is based on a numerology. A numerology may define a frequency domain subcarrier spacing and symbol duration, and may be configured for a given bandwidth part, carrier, cell, or network entity. In certain aspects, given a numerology μ, there are 2^{μ} slots per subframe. Thus, numerologies (μ) 0 to 6 may allow for 1, 2, 4, 8, 16, 32, and 64 slots, respectively, per subframe. In some cases, an extended CP (e.g., 12 symbols per slot) may be used with a specific numerology, such as numerology μ=2 allowing for 4 slots per subframe. The subcarrier spacing and symbol length/duration are a function of the numerology. The subcarrier spacing may be equal to 2^{μ}×15 kHz. As an example, the numerology μ=0 corresponds to a subcarrier spacing of 15 kHz, and the numerology μ=6 corresponds to a subcarrier spacing of 960 kHz. The symbol length/duration is inversely related to the subcarrier spacing. FIGS. 4A, 4B, 4C, and 4D provide an example of a slot format having 14 symbols per slot (e.g., a normal CP) and a numerology μ=2 with 4 slots per subframe. In such a case, the slot duration is 0.25 ms, the subcarrier spacing is 60 kHz, and the symbol duration is approximately 16.67 μs.

As depicted in FIGS. 4A, 4B, 4C, and 4D, a resource grid may be used to represent the frame structure. Each time slot includes a resource block (RB) (also referred to as a physical RB (PRB)) that extends across, for example, 12 consecutive subcarriers. The resource grid is divided into multiple resource elements (REs). An RE may include a single subcarrier in the frequency domain and a single symbol in the time domain. The number of bits carried by each RE depends on the modulation scheme including, for example, quadrature phase shift keying (QPSK) or quadrature amplitude modulation (QAM).

As illustrated in FIG. 4A, some of the REs carry reference (pilot) signals (shown as “RS”) for a UE (e.g., UE 104 of FIGS. 1 and 3). The RS may include a demodulation RS (DMRS) and/or a channel state information reference signals (CSI-RS) for channel estimation at the UE. The RS may additionally or alternatively include a beam measurement RS (BRS), a beam refinement RS (BRRS), and/or a phase tracking RS (PT-RS).

FIG. 4B illustrates an example of various DL channels within a subframe of a frame. The physical downlink control channel (PDCCH) carries DCI within one or more control channel elements (CCEs), each CCE including, for example, nine RE groups (REGs), each REG including, for example, four consecutive REs in an OFDM symbol.

A primary synchronization signal (PSS) may be within symbol 2 of particular subframes of a frame. The PSS is used by a UE (e.g., 104 of FIGS. 1 and 3) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DMRS. The physical broadcast channel (PBCH), which carries a master information block (MIB), may be logically grouped with the PSS and SSS to form a synchronization signal (SS)/PBCH block (SSB), and in some cases, referred to as a synchronization signal block (SSB). The MIB provides a number of RBs in the system bandwidth and a system frame number (SFN). The physical downlink shared channel (PDSCH) carries user data, broadcast system information not transmitted through the PBCH such as system information blocks (SIBs), and/or paging messages.

As illustrated in FIG. 4C, some of the REs carry DMRS (indicated as “R” for one particular configuration, but other DMRS configurations are possible) for channel estimation at the base station. The UE may transmit DMRS for the PUCCH and DMRS for the PUSCH. The PUSCH DMRS may be transmitted, for example, in the first one or two symbols of the PUSCH. The PUCCH DMRS may be transmitted in different configurations depending on whether short or long PUCCHs are transmitted and depending on the particular PUCCH format used. UE 104 may transmit sounding reference signals (SRS). The SRS may be transmitted, for example, in the last symbol of a subframe. The SRS may have a comb structure, and a UE may transmit SRS on one of the combs. The SRS may be used by a base station for channel quality estimation to enable frequency-dependent scheduling on the UL.

FIG. 4D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

### Example Artificial Intelligence for Wireless Communications

Certain aspects described herein may be implemented, at least in part, using some form of artificial intelligence (AI), e.g., the process of using a machine learning (ML) model to infer or predict output data based on input data. An example ML model may include a mathematical representation of one or more relationships among various objects to provide an output representing one or more predictions or inferences. Once an ML model has been trained, the ML model may be deployed to process data that may be similar to, or associated with, all or part of the training data and provide an output representing one or more predictions or inferences based on the input data.

ML is often characterized in terms of types of learning that generate specific types of learned models that perform specific types of tasks. For example, different types of machine learning include supervised learning, unsupervised learning, semi-supervised learning, and reinforcement learning.

Supervised learning algorithms generally model relationships and dependencies between input features (e.g., a feature vector) and one or more target outputs. Supervised learning uses labeled training data, which are data including one or more inputs and a desired output. Supervised learning may be used to train models to perform tasks like classification, where the goal is to predict discrete values, or regression, where the goal is to predict continuous values. Some example supervised learning algorithms include nearest neighbor, naive Bayes, decision trees, linear regression, support vector machines (SVMs), and artificial neural networks (ANNs).

Unsupervised learning algorithms work on unlabeled input data and train models that take an input and transform it into an output to solve a practical problem. Examples of unsupervised learning tasks are clustering, where the output of the model may be a cluster identification, dimensionality reduction, where the output of the model is an output feature vector that has fewer features than the input feature vector, and outlier detection, where the output of the model is a value indicating how the input is different from a typical example in the dataset. An example unsupervised learning algorithm is k-Means.

Semi-supervised learning algorithms work on datasets containing both labeled and unlabeled examples, where often the quantity of unlabeled examples is much higher than the number of labeled examples. However, the goal of a semi-supervised learning is that of supervised learning. Often, a semi-supervised model includes a model trained to produce pseudo-labels for unlabeled data that is then combined with the labeled data to train a second classifier that leverages the higher quantity of overall training data to improve task performance.

Reinforcement learning algorithms use observations gathered by an agent from an interaction with an environment to take actions that may maximize a reward or minimize a risk. Reinforcement learning is a continuous and iterative process in which the agent learns from its experiences with the environment until it explores, for example, a full range of possible states. An example type of reinforcement learning algorithm is an adversarial network. Reinforcement learning may be particularly beneficial when used to improve or attempt to optimize a behavior of a model deployed in a dynamically changing environment, such as a wireless communication network.

ML models may be deployed in one or more devices (e.g., network entities such as base station(s) and/or user equipment(s)) to support various wired and/or wireless communication aspects of a communication system. For example, an ML model may be trained to identify patterns and relationships in data corresponding to a network, a device, an air interface, or the like. An ML model may improve operations relating to one or more aspects, such as transceiver circuitry controls, frequency synchronization, timing synchronization, channel state estimation, channel equalization, channel state feedback, modulation, demodulation, device positioning, transceiver tuning, beamforming, signal coding/decoding, network routing, load balancing, and energy conservation (to name just a few) associated with communications devices, services, and/or networks. AI-enhanced transceiver circuitry controls may include, for example, filter tuning, transmit power controls, gain controls (including automatic gain controls), phase controls, power management, and the like.

Aspects described herein may describe the performance of certain tasks and the technical solution of various technical problems by application of a specific type of ML model, such as an ANN. It should be understood, however, that other type(s) of AI models may be used in addition to or instead of an ANN. An ML model may be an example of an AI model, and any suitable AI model may be used in addition to or instead of any of the ML models described herein. Hence, unless expressly recited, subject matter regarding an ML model is not necessarily intended to be limited to just an ANN solution or machine learning. Further, it should be understood that, unless otherwise specifically stated, terms such “LLM,” “AI model,” “ML model,” “AI/ML model,” “trained ML model,” and the like are intended to be interchangeable.

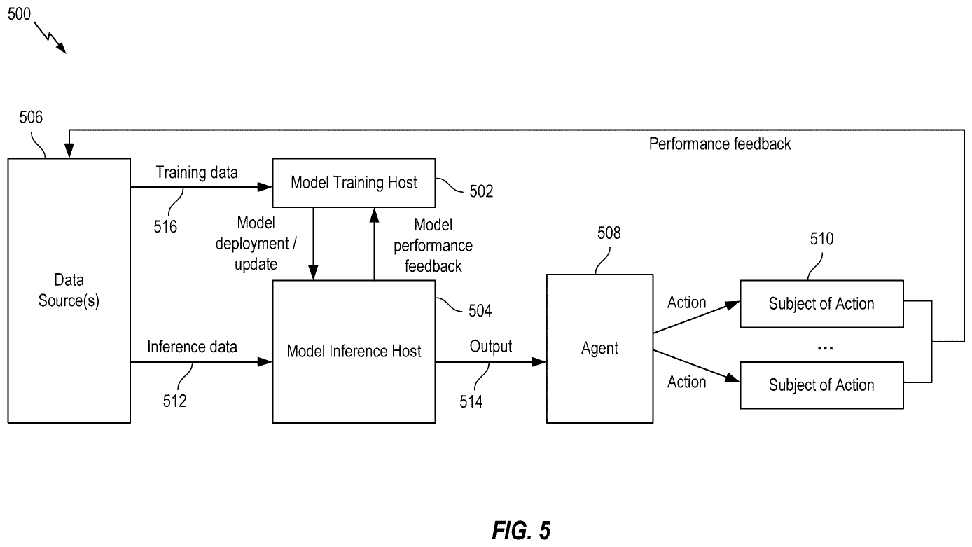

FIG. 5 is a diagram illustrating an example AI architecture 500 that may be used for AI-enhanced wireless communications. As illustrated, the architecture 500 includes multiple logical entities, such as a model training host 502, a model inference host 504, data source(s) 506, and an agent 508. The AI architecture may be used in any of various use cases for wireless communications, such as those listed above.

The model inference host 504, in the architecture 500, is configured to run an ML model based on inference data 512 provided by data source(s) 506. The model inference host 504 may produce an output 514 (e.g., a prediction or inference, such as a discrete or continuous value) based on the inference data 512, that is then provided as input to the agent 508. In certain aspects, the model inference host 504 may be an example of a model inference agent.

The agent 508 may be an element or an entity of a wireless communication system including, for example, a radio access network (RAN), a wireless local area network, a device-to-device (D2D) communications system, etc. In certain examples, the agent 508 may be an example of a decision agent. In some examples, the agent 508 may be a UE, a base station, or any disaggregated network entity thereof including a CU, a DU, and/or an RU, an access point, a wireless station, a RIC in a cloud-based RAN, among some examples. Additionally, the type of agent 508 may also depend on the type of tasks performed by the model inference host 504, the type of inference data 512 provided to model inference host 504, and/or the type of output 514 produced by model inference host 504.

For example, if output 514 from the model inference host 504 is associated with beam management, the agent 508 may be or include a UE, a DU, or an RU. As another example, if output 514 from model inference host 504 is associated with transmission and/or reception scheduling, the agent 508 may be a CU or a DU.

After the agent 508 receives output 514 from the model inference host 504, agent 508 may determine whether to act based on the output. For example, if agent 508 is a DU or an RU and the output from model inference host 504 is associated with beam management, the agent 508 may determine whether to change or modify a transmit and/or receive beam based on the output 514. If the agent 508 determines to act based on the output 514, agent 508 may indicate the action to at least one subject of the action 510. For example, if the agent 508 determines to change or modify a transmit and/or receive beam for a communication between the agent 508 and the subject of action 510 (e.g., a UE), the agent 508 may send a beam switching indication to the subject of action 510 (e.g., a UE). As another example, the agent 508 may be a UE, the output 514 from model inference host 504 may be one or more predicted channel characteristics for one or more beams. For example, the model inference host 504 may predict channel characteristics for a set of beams based on the measurements of another set of beams. Based on the predicted channel characteristics, the agent 508, such as the UE, may send, to the subject of action 510, such as a BS, a request to switch to a different beam for communications. In some cases, the agent 508 and the subject of action 510 are the same entity.

The data sources 506 may be configured for collecting data that is used as training data 516 for training an ML model, or as inference data 512 for feeding an ML model inference operation. In particular, the data sources 506 may collect data from any of various entities (e.g., the UE and/or the BS), which may include the subject of action 510, and provide the collected data to a model training host 502 for ML model training. For example, after a subject of action 510 (e.g., a UE) receives a beam configuration from agent 508, the subject of action 510 may provide performance feedback associated with the beam configuration to the data sources 506, where the performance feedback may be used by the model training host 502 for monitoring and/or evaluating the ML model performance, such as whether the output 514, provided to agent 508, is accurate. In some examples, if the output 514 provided to agent 508 is inaccurate (or the accuracy is below an accuracy threshold), the model training host 502 may determine to modify or retrain the ML model used by model inference host 504, such as via an ML model deployment/update.

In certain aspects, the model training host 502 may be deployed at or with the same or a different entity than that in which the model inference host 504 is deployed. For example, in order to offload model training processing, which can impact the performance of the model inference host 504, the model training host 502 may be deployed at a model server as further described herein. Further, in some cases, training and/or inference may be distributed amongst devices in a decentralized or federated fashion.

In certain aspects, an ML model is deployed at or on a UE for LLM processing or inference. More specifically, a model inference host, such as model inference host 504 in FIG. 5, may be deployed at or on the UE for distributed LLM processing, as further described herein with respect to FIGS. 9-12.

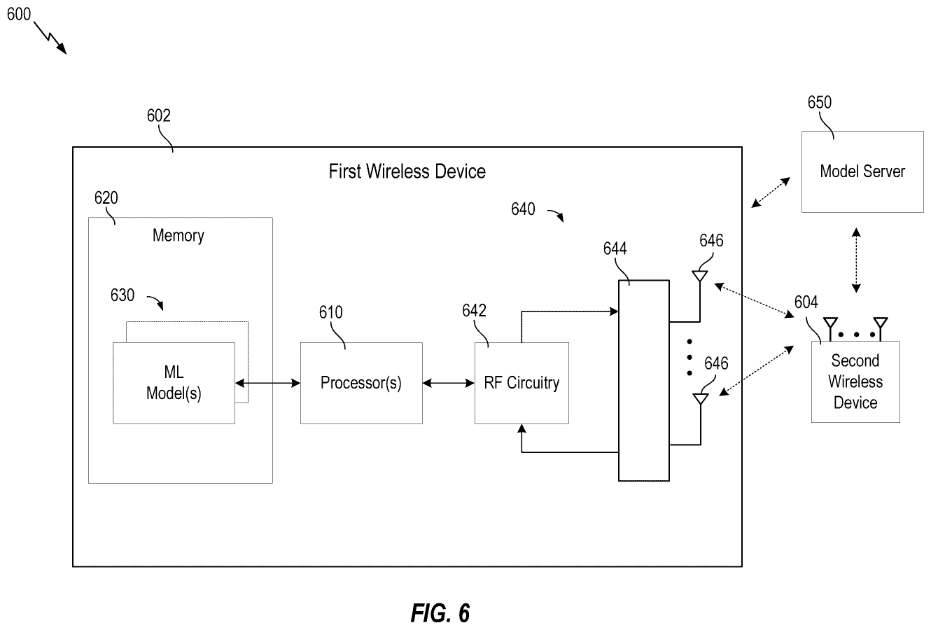

FIG. 6 illustrates an example AI architecture 600 of a first wireless device 602 that is in communication with a second wireless device 604. The first wireless device 602 may be a UE as described herein with respect to FIGS. 1-3. Similarly, the second wireless device 604 may be a network entity or network node as described herein with respect to FIGS. 1-3. Note that the AI architecture of the first wireless device 602 may be applied to the second wireless device 604.

The first wireless device 602 may be, or may include, a chip, system on chip (SoC), a system in package (SiP), chipset, package or device that includes one or more processors, processing blocks or processing elements (hereinafter “the processor 610”) and one or more memory blocks or elements (hereinafter “the memory 620”).

As an example, in a transmit mode, the processor 610 may transform information (e.g., packets or data blocks) into modulated symbols. As digital baseband signals (e.g., digital in-phase (I) and/or quadrature (Q) baseband signals representative of the respective symbols), the processor 610 may output the modulated symbols to a transceiver 640. The processor 610 may be coupled to the transceiver 640 for transmitting and/or receiving signals via one or more antennas 646. In this example, the transceiver 640 includes radio frequency (RF) circuitry 642, which may be coupled to the antennas 646 via an interface 644. As an example, the interface 644 may include a switch, a duplexer, a diplexer, a multiplexer, and/or the like. The RF circuitry 642 may convert the digital signals to analog baseband signals, for example, using a digital-to-analog converter. The RF circuitry 642 may include any of various circuitry, including, for example, baseband filter(s), mixer(s), frequency synthesizer(s), power amplifier(s), and/or low noise amplifier(s). In some cases, the RF circuitry 642 may upconvert the baseband signals to one or more carrier frequencies for transmission. The antennas 646 may emit RF signals, which may be received at the second wireless device 604.

In receive mode, RF signals received via the antenna 646 (e.g., from the second wireless device 604) may be amplified and converted to a baseband frequency (e.g., downconverted). The received baseband signals may be filtered and converted to digital I or Q signals for digital signal processing. The processor 610 may receive the digital I or Q signals and further process the digital signals, for example, demodulating the digital signals.

One or more ML models 630 may be stored in the memory 620 and accessible to the processor(s) 610. In certain cases, different ML models 630 with different characteristics may be stored in the memory 620, and a particular ML model 630 may be selected based on its characteristics and/or application as well as characteristics and/or conditions of first wireless device 602 (e.g., a power state, a mobility state, a battery reserve, a temperature, etc.). For example, the ML models 630 may have different inference data and output pairings (e.g., different types of inference data produce different types of output), different levels of accuracies (e.g., 80%, 90%, or 95% accurate) associated with the predictions (e.g., the output 514 of FIG. 5), different latencies (e.g., processing times of less than 10 ms, 100 ms, or 1 second) associated with producing the predictions, different ML model sizes (e.g., file sizes), different coefficients or weights, etc.

The processor 610 may use the ML model 630 to produce output data (e.g., the output 514 of FIG. 5) based on input data (e.g., the inference data 512 of FIG. 5), for example, as described herein with respect to the inference host 504 of FIG. 5. The ML model 630 may be used to perform any of various AI-enhanced tasks, such as those listed above.

As an example, the ML model 630 may take measurements of a reference signal (e.g., corresponding to a wide beam) as input to predict a channel characteristic associated with a different reference signal (e.g., corresponding to a narrow beam within the wide beam, another wide beam, a narrow beam outside the wide beam, etc.). The input data may include, for example, measurements of one or more reference or pilot signals, such as a channel quality indicator (CQI), a signal-to-noise ratio (SNR), a signal-to-interference plus noise ratio (SINR), a signal-to-noise-plus-distortion ratio (SNDR), a received signal strength indicator (RSSI), a reference signal received power (RSRP), a reference signal received quality (RSRQ), and/or a block error rate (BLER). The output data may include, for example, one or more predicted measurements (or characteristics) of one or more reference or pilot signals, which may be different from the reference or pilot signals associated with the input data. In certain aspects, the one or more reference or pilot signals for which the one or more measurements are predicted may be considered “virtual resources” in they are not actually transmitted, but the measurements are predicted as though they were transmitted. In certain aspects, the one or more reference or pilot signals for which the one or more measurements are predicted may actually be transmitted but not actually measured by first wireless device 602. Note that other input data and/or output data may be used in addition to or instead of the examples described herein.

In certain aspects, a model server 650 may perform any of various ML model lifecycle management (LCM) tasks for the first wireless device 602 and/or the second wireless device 604. The model server 650 may operate as the model training host 502 and update the ML model 630 using training data. In some cases, the model server 650 may operate as the data source 506 to collect and host training data, inference data, and/or performance feedback associated with an ML model 630. In certain aspects, the model server 650 may host various types and/or versions of the ML models 630 for the first wireless device 602 and/or the second wireless device 604 to download.

In some cases, the model server 650 may monitor and evaluate the performance of the ML model 630 to trigger one or more LCM tasks. For example, the model server 650 may determine whether to activate or deactivate the use of a particular ML model at the first wireless device 602 and/or the second wireless device 604, and the model server 650 may provide such an instruction to the respective first wireless device 602 and/or the second wireless device 604. In some cases, the model server 650 may determine whether to switch to a different ML model 630 being used at the first wireless device 602 and/or the second wireless device 604, and the model server 650 may provide such an instruction to the respective first wireless device 602 and/or the second wireless device 604. In yet further examples, the model server 650 may also act as a central server for decentralized machine learning tasks, such as federated learning.

### Example Artificial Intelligence Model

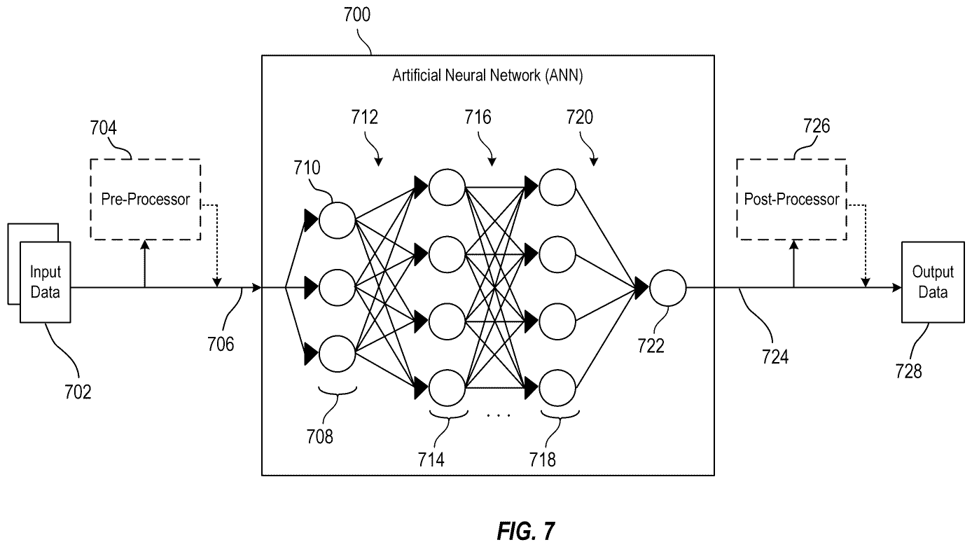

FIG. 7 is an illustrative block diagram of an example artificial neural network (ANN) 700.

ANN 700 may receive input data 706 which may include one or more bits of data 702, pre-processed data output from pre-processor 704 (optional), or some combination thereof. Here, data 702 may include training data, verification data, application-related data, or the like, e.g., depending on the stage of development and/or deployment of ANN 700. Pre-processor 704 may be included within ANN 700 in some other implementations. Pre-processor 704 may, for example, process all or a portion of data 702 which may result in some of data 702 being changed, replaced, deleted, etc. In some implementations, pre-processor 704 may add additional data to data 702.

ANN 700 includes at least one first layer 708 of artificial neurons 710 (e.g., perceptrons) to process input data 706 and provide resulting first layer output data via edges 712 to at least a portion of at least one second layer 714. Second layer 714 processes data received via edges 712 and provides second layer output data via edges 716 to at least a portion of at least one third layer 718. Third layer 718 processes data received via edges 716 and provides third layer output data via edges 720 to at least a portion of a final layer 722 including one or more neurons to provide output data 724. All or part of output data 724 may be further processed in some manner by (optional) post-processor 726. Thus, in certain examples, ANN 700 may provide output data 728 that is based on output data 724, post-processed data output from post-processor 726, or some combination thereof. Post-processor 726 may be included within ANN 700 in some other implementations. Post-processor 726 may, for example, process all or a portion of output data 724 which may result in output data 728 being different, at least in part, to output data 724, e.g., as result of data being changed, replaced, deleted, etc. In some implementations, post-processor 726 may be configured to add additional data to output data 724. In this example, second layer 714 and third layer 718 represent intermediate or hidden layers that may be arranged in a hierarchical or other like structure. Although not explicitly shown, there may be one or more further intermediate layers between the second layer 714 and the third layer 718.

The structure and training of artificial neurons 710 in the various layers may be tailored to specific requirements of an application. Within a given layer of an ANN, some or all of the neurons may be configured to process information provided to the layer and output corresponding transformed information from the layer. For example, transformed information from a layer may represent a weighted sum of the input information associated with or otherwise based on a non-linear activation function or other activation function used to “activate” artificial neurons of a next layer. Artificial neurons in such a layer may be activated by or be responsive to weights and biases that may be adjusted during a training process. Weights of the various artificial neurons may act as parameters to control a strength of connections between layers or artificial neurons, while biases may act as parameters to control a direction of connections between the layers or artificial neurons. An activation function may select or determine whether an artificial neuron transmits its output to the next layer or not in response to its received data. Different activation functions may be used to model different types of non-linear relationships. By introducing non-linearity into an ML model, an activation function allows the ML model to “learn” complex patterns and relationships in the input data (e.g., 506 in FIG. 5). Some non-exhaustive example activation functions include a linear function, binary step function, sigmoid, hyperbolic tangent (tanh), a rectified linear unit (ReLU) and variants, exponential linear unit (ELU), Swish, Softmax, and others.

Design tools (such as computer applications, programs, etc.) may be used to select appropriate structures for ANN 700 and a number of layers and a number of artificial neurons in each layer, as well as selecting activation functions, a loss function, training processes, etc. Once an initial model has been designed, training of the model may be conducted using training data. Training data may include one or more datasets within which ANN 700 may detect, determine, identify or ascertain patterns. Training data may represent various types of information, including written, visual, audio, environmental context, operational properties, etc. During training, parameters of artificial neurons 710 may be changed, such as to minimize or otherwise reduce a loss function or a cost function. A training process may be repeated multiple times to fine-tune ANN 700 with each iteration.

Various ANN model structures are available for consideration. For example, in a feedforward ANN structure each artificial neuron 710 in a layer receives information from the previous layer and likewise produces information for the next layer. In a convolutional ANN structure, some layers may be organized into filters that extract features from data (e.g., training data and/or input data). In a recurrent ANN structure, some layers may have connections that allow for processing of data across time, such as for processing information having a temporal structure, such as time series data forecasting.

In an autoencoder ANN structure, compact representations of data may be processed and the model trained to predict or potentially reconstruct original data from a reduced set of features. An autoencoder ANN structure may be useful for tasks related to dimensionality reduction and data compression.

A generative adversarial ANN structure may include a generator ANN and a discriminator ANN that are trained to compete with each other. Generative-adversarial networks (GANs) are ANN structures that may be useful for tasks relating to generating synthetic data or improving the performance of other models.

A transformer ANN structure makes use of attention mechanisms that may enable the model to process input sequences in a parallel and efficient manner. An attention mechanism allows the model to focus on different parts of the input sequence at different times. Attention mechanisms may be implemented using a series of layers known as attention layers to compute, calculate, determine or select weighted sums of input features based on a similarity between different elements of the input sequence. A transformer ANN structure may include a series of feedforward ANN layers that may learn non-linear relationships between the input and output sequences. The output of a transformer ANN structure may be obtained by applying a linear transformation to the output of a final attention layer. A transformer ANN structure may be of particular use for tasks that involve sequence modeling, or other like processing.

Another example type of ANN structure, is a model with one or more invertible layers. Models of this type may be inverted or “unwrapped” to reveal the input data that was used to generate the output of a layer.

Other example types of ANN model structures include fully connected neural networks (FCNNs) and long short-term memory (LSTM) networks.

ANN 700 or other ML models may be implemented in various types of processing circuits along with memory and applicable instructions therein, for example, as described herein with respect to FIGS. 5 and 6. For example, general-purpose hardware circuits, such as, such as one or more central processing units (CPUs) and one or more graphics processing units (GPUs) may be employed to implement a model. One or more ML accelerators, such as tensor processing units (TPUs), embedded neural processing units (eNPUs), or other special-purpose processors, and/or field-programmable gate arrays (FPGAs), application-specific integrated circuits (ASICs), or the like also may be employed. Various programming tools are available for developing ANN models.

### Aspects of Artificial Intelligence Model Training

There are a variety of model training techniques and processes that may be used prior to, or at some point following, deployment of an ML model, such as ANN 700 of FIG. 7.

As part of a model development process, information in the form of applicable training data may be gathered or otherwise created for use in training an ML model accordingly. For example, training data may be gathered or otherwise created regarding information associated with received/transmitted signal strengths, interference, and resource usage data, as well as any other relevant data that might be useful for training a model to address one or more problems or issues in a communication system. In certain instances, all or part of the training data may originate in one or more user equipments (UEs), one or more network entities, or one or more other devices in a wireless communication system. In some cases, all or part of the training data may be aggregated from multiple sources (e.g., one or more UEs, one or more network entities, the Internet, etc.). For example, wireless network architectures, such as self-organizing networks (SONs) or mobile drive test (MDT) networks, may be adapted to support collection of data for ML model applications. In another example, training data may be generated or collected online, offline, or both online and offline by a UE, network entity, or other device(s), and all or part of such training data may be transferred or shared (in real or near-real time), such as through store and forward functions or the like. Offline training may refer to creating and using a static training dataset, e.g., in a batched manner, whereas online training may refer to a real-time or near-real-time collection and use of training data. For example, an ML model at a network device (e.g., a UE) may be trained and/or fine-tuned using online or offline training. For offline training, data collection and training can occur in an offline manner at the network side (e.g., at a base station or other network entity) or at the UE side. For online training, the training of a UE-side ML model may be performed locally at the UE or by a server device (e.g., a server hosted by a UE vendor) in a real-time or near-real-time manner based on data provided to the server device from the UE.

In certain instances, all or part of the training data may be shared within a wireless communication system, or even shared (or obtained from) outside of the wireless communication system.

Once an ML model has been trained with training data, its performance may be evaluated. In some scenarios, evaluation/verification tests may use a validation dataset, which may include data not in the training data, to compare the model's performance to baseline or other benchmark information. If model performance is deemed unsatisfactory, it may be beneficial to fine-tune the model, e.g., by changing its architecture, re-training it on the data, or using different optimization techniques, etc. Once a model's performance is deemed satisfactory, the model may be deployed accordingly. In certain instances, a model may be updated in some manner, e.g., all or part of the model may be changed or replaced, or undergo further training, just to name a few examples.

As part of a training process for an ANN, such as ANN 700 of FIG. 7, parameters affecting the functioning of the artificial neurons and layers may be adjusted. For example, backpropagation techniques may be used to train the ANN by iteratively adjusting weights and/or biases of certain artificial neurons associated with errors between a predicted output of the model and a desired output that may be known or otherwise deemed acceptable. Backpropagation may include a forward pass, a loss function, a backward pass, and a parameter update that may be performed in training iteration. The process may be repeated for a certain number of iterations for each set of training data until the weights of the artificial neurons/layers are adequately tuned.

Backpropagation techniques associated with a loss function may measure how well a model is able to predict a desired output for a given input. An optimization algorithm may be used during a training process to adjust weights and/or biases to reduce or minimize the loss function which should improve the performance of the model. There are a variety of optimization algorithms that may be used along with backpropagation techniques or other training techniques. Some initial examples include a gradient descent based optimization algorithm and a stochastic gradient descent based optimization algorithm. A stochastic gradient descent (or ascent) technique may be used to adjust weights/biases in order to minimize or otherwise reduce a loss function. A mini-batch gradient descent technique, which is a variant of gradient descent, may involve updating weights/biases using a small batch of training data rather than the entire dataset. A momentum technique may accelerate an optimization process by adding a momentum term to update or otherwise affect certain weights/biases.

An adaptive learning rate technique may adjust a learning rate of an optimization algorithm associated with one or more characteristics of the training data. A batch normalization technique may be used to normalize inputs to a model in order to stabilize a training process and potentially improve the performance of the model.

A “dropout” technique may be used to randomly drop out some of the artificial neurons from a model during a training process, e.g., in order to reduce overfitting and potentially improve the generalization of the model.

An “early stopping” technique may be used to stop an on-going training process early, such as when a performance of the model using a validation dataset starts to degrade.

Another example technique includes data augmentation to generate additional training data by applying transformations to all or part of the training information.

A transfer learning technique may be used which involves using a pre-trained model as a starting point for training a new model, which may be useful when training data is limited or when there are multiple tasks that are related to each other.

A multi-task learning technique may be used which involves training a model to perform multiple tasks simultaneously to potentially improve the performance of the model on one or more of the tasks. Hyperparameters or the like may be input and applied during a training process in certain instances.

Another example technique that may be useful with regard to an ML model is some form of a “pruning” technique. A pruning technique, which may be performed during a training process or after a model has been trained, involves the removal of unnecessary (e.g., because they have no impact on the output) or less necessary (e.g., because they have negligible impact on the output), or possibly redundant features from a model. In certain instances, a pruning technique may reduce the complexity of a model or improve efficiency of a model without undermining the intended performance of the model.

Pruning techniques may be particularly useful in the context of wireless communication, where the available resources (such as power and bandwidth) may be limited. Some example pruning techniques include a weight pruning technique, a neuron pruning technique, a layer pruning technique, a structural pruning technique, and a dynamic pruning technique. Pruning techniques may, for example, reduce the amount of data corresponding to a model that may need to be transmitted or stored.

Weight pruning techniques may involve removing some of the weights from a model. Neuron pruning techniques may involve removing some neurons from a model. Layer pruning techniques may involve removing some layers from a model. Structural pruning techniques may involve removing some connections between neurons in a model. Dynamic pruning techniques may involve adapting a pruning strategy of a model associated with one or more characteristics of the data or the environment. For example, in certain wireless communication devices, a dynamic pruning technique may more aggressively prune a model for use in a low-power or low-bandwidth environment, and less aggressively prune the model for use in a high-power or high-bandwidth environment. In certain aspects, pruning techniques also may be applied to training data, e.g., to remove outliers, etc. In some implementations, pre-processing techniques directed to all or part of a training dataset may improve model performance or promote faster convergence of a model. For example, training data may be pre-processed to change or remove unnecessary data, extraneous data, incorrect data, or otherwise identifiable data. Such pre-processed training data may, for example, lead to a reduction in potential overfitting, or otherwise improve the performance of the trained model.

One or more of the example training techniques presented above may be employed as part of a training process. As above, some example training processes that may be used to train an ML model include supervised learning, unsupervised learning, semi-supervised learning, and reinforcement learning technique.

Decentralized, distributed, or shared learning, such as federated learning, may enable training on data distributed across multiple devices or organizations, without the need to centralize data or the training. Federated learning may be particularly useful in scenarios where data is sensitive or subject to privacy constraints, or where it is impractical, inefficient, or expensive to centralize data. In the context of wireless communication, for example, federated learning may be used to improve performance by allowing an ML model to be trained on data collected from a wide range of devices and environments. For example, an ML model may be trained on data collected from a large number of wireless devices in a network, such as distributed wireless communication nodes, smartphones, or internet-of-things (IoT) devices, to improve the network's performance and efficiency. With federated learning, a user equipment (UE) or other device may receive a copy of all or part of a model and perform local training on such copy of all or part of the model using locally available training data. Such a device may provide update information (e.g., trainable parameter gradients) regarding the locally trained model to one or more other devices (such as a network entity or a server) where the updates from other-like devices (such as other UEs) may be aggregated and used to provide an update to a shared model or the like. A federated learning process may be repeated iteratively until all or part of a model obtains a satisfactory level of performance. Federated learning may enable devices to protect the privacy and security of local data, while supporting collaboration regarding training and updating of all or part of a shared model.

In some implementations, one or more devices or services may support processes relating to a ML model's usage, maintenance, activation, reporting, or the like. In certain instances, all or part of a dataset or model may be shared across multiple devices, e.g., to provide or otherwise augment or improve processing. In some examples, signaling mechanisms may be utilized at various nodes of wireless network to signal the capabilities for performing specific functions related to ML model, support for specific ML models, capabilities for gathering, creating, transmitting training data, or other ML related capabilities. ML models in wireless communication systems may, for example, be employed to support decisions relating to wireless resource allocation or selection, wireless channel condition estimation, interference mitigation, beam management, positioning accuracy, energy savings, or modulation or coding schemes, etc. In some implementations, model deployment may occur jointly or separately at various network levels, such as, a central unit (CU), a distributed unit (DU), a radio unit (RU), or the like.

### Example Protocol Stacks

Certain wireless communications systems (e.g., 5G NR systems or any future wireless communications system) may employ protocol stack(s) to transfer information between a UE and a network node, such as a base station and/or core network. As an example, 5G NR systems may use a user plane protocol stack and a control plane protocol stack to exchange application data and signaling messages. A user plane protocol stack may be responsible for transferring application data between the UE and an application server, and a control plane protocol stack may be responsible for transferring control signaling messages between the UE and a network node.

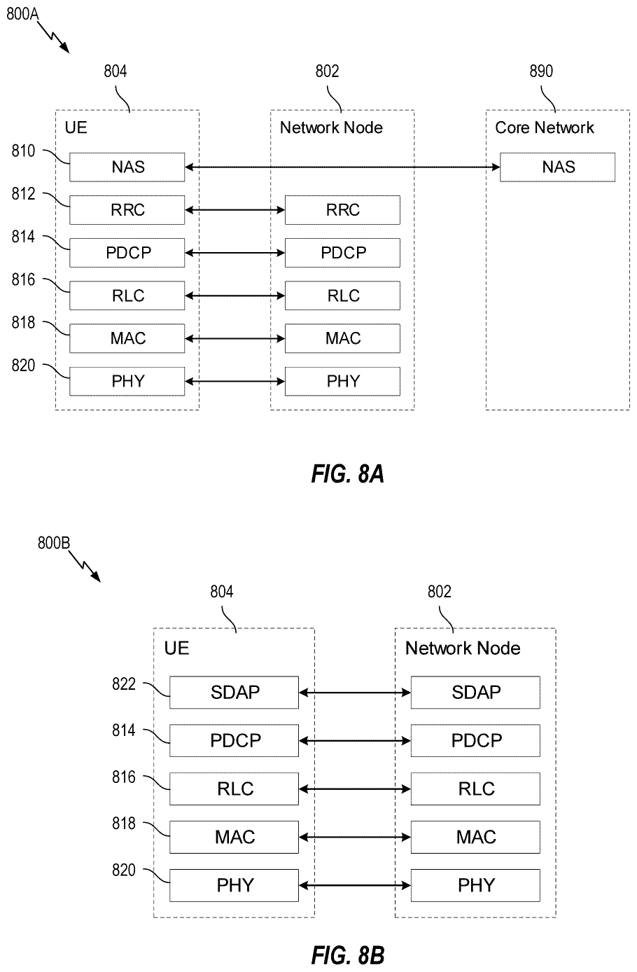

FIG. 8A depicts an example control plane protocol stack 800A for exchanging control plane traffic (e.g., control signaling) between a user equipment (UE) 804 and a network node 802, and between the UE 804 and a core network 890. In some aspects, the network node 802 may be an example of the BS and/or network entities depicted and described with respect to FIGS. 1 and 3 or a disaggregated base station depicted and described with respect to FIG. 2. Similarly, the UE 804 may be an example of UE depicted and described with respect to FIGS. 1 and 3. The core network 890 may be an example of the 5GC network 190 and/or the core network 220 depicted and described with respect to FIGS. 1 and 2, respectively.

The control plane protocol stack 800A includes a non-access stratum (NAS) layer 810, a radio resource control (RRC) layer 812, a packet data convergence protocol (PDCP) layer 814, a radio link control (RLC) layer 816, a medium access control (MAC) layer 818, and a physical (PHY) layer 820. The NAS layer 810 carries mobility management and session management signaling between the UE 804 and the core network 890 (e.g., the AMF 192 and/or the SMF 194 of FIG. 1). The RRC layer 812 carries RRC signaling, for example, for paging, RRC connection establishment, RRC connection reconfiguration, and RRC connection release. The PDCP layer 814 provides ciphering and integrity protection for control plane signaling. The RLC layer 816 may segment a large packet into smaller packets and handles re-transmissions of RLC packets. The MAC layer 818 schedules transmissions between the UE 804 and the network node 802 and controls the PHY layer. In the MAC layer 818, the UE 804 and the network node 802 may communicate with each other by exchanging a MAC control element (MAC-CE). The PHY layer 820 handles transmission and reception across the air-interface between the UE 804 and the network node 802. The PHY layer 820 provides certain error management tasks (e.g., cyclic redundancy check), certain digital signaling processing tasks (e.g., modulation and demodulation), and handles certain procedures for measurement and control (e.g., beam failure detection and/or radio link monitoring). The network node 802 may send, to the UE 804, PHY layer signaling via downlink control information (DCI).

FIG. 8B depicts an example user plane protocol stack 800B for exchanging user plane traffic (e.g., application data) between the UE 804 and the network node 802. The user plane protocol stack 800B includes a service data adaptation protocol (SDAP) layer 822, the PDCP layer 814, the RLC layer 816, the MAC layer 818, and the PHY layer 820. The SDAP layer 822 maps the quality of service (QoS) flow(s) used at the core network 890 (e.g., for a protocol data unit (PDU) session) to data radio bearer(s) used at the network node 802 to communicate via an air-interface between the UE 804 and the network node 802. In the user plane, the PDCP layer 814 provides packet header compression (e. g, transmission control protocol (TCP), user datagram protocol (UDP), and/or internet protocol (IP) header compression), ciphering, and integrity protection for user plane traffic.

The RRC layer 812 may form Layer-3 (L3) of the control plane protocol stack 800A. In the user plane, the SDAP layer 822, the PDCP layer 814, the RLC layer 816, and/or the MAC layer 818 may form Layer-2 (L2) of the user plane protocol stack 800B. In the control plane, the PDCP layer 814, the RLC layer 816, and/or the MAC layer 818 may form L2 of the control plane protocol stack 800A. The PHY layer 820 may form Layer-1 (L1) of the protocol stacks 800A, 800B. Layer-3 may include the highest or upper layers in the control plane protocol stack 800A; Layer-2 may include the intermediate layers in the control plane protocol stack 800A, where Layer-2 is arranged between Layer-3 and Layer-1; and Layer-1 may include the lowest layer in the control plane protocol stack 800A.

### Aspects Related to Capability Reporting for Distributed Language Model Processing

Aspects of the present disclosure provides techniques for reporting certain information associated with distributed LLM processing, such as computational capabilities and/or the status of computational resources. The communication of the capability information and/or status information may enable reduced latencies in processing LLM data and/or enable reliable and accurate LLM data generation.

FIG. 9 depicts an example 900 of LLM segmentation for distributed LLM processing. In this example, an LLM 902 may include multiple LLM layers (such as pretrained LLM layers). The LLM 902 may be or include a deep learning language model, a generative transformer model, a decoder-only autoregressive model, a decoder-only transformer model, a neural network (such as the ANN 700 of FIG. 7), and/or the like. The pretrained LLM layers may mean that the layers of the LLM have undergone at least an initial phase of training based on a diverse training dataset. The LLM 902 may be configured as a stack or sequence of LLM layers (such as the LLM layers 904a, 904b, 904n). Each of the LLM layers may be or include one or more pre-trained neural networks (such as the ANN 700 of FIG. 7).

As an example, the LLM 902 may have a decoder-only LLM architecture including a set of neural network decoders. Input data 906 may be processed sequentially through the LLM layers of the LLM 902, for example, using forward propagation. As a part of auto-regressive inference, the LLM 902 may generate one or more tokens and append the token(s) to the input data 906, and subsequent token(s) may be generated based on the new input data. The LLM 902 may form a processing pipeline of LLM layers, such that the output of an LLM layer (e.g., the first LLM layer(s) 904a) is the input of the next LLM layer in the pipeline (e.g., the second LLM layer(s) 904b). The LLM layer may receive input, generate output, and feed that output to the next LLM layer in the pipeline. The input data 906 may be fed or provided to the LLM 902, and the LLM 902 may generate output data 908 including, for example, one or more inferences, one or more predictions, LLM generated content (such as text, image(s), video, or the like), and/or the like.

In certain aspects, the LLM 902 may include one or more embedding layers, one or more deep learning language model layers, one or more sampling layers, and/or one or more heads. As an example, the embedding layer(s) may receive the input data, convert the input data into embeddings, and feed the embeddings to the deep learning language model layers. The deep learning language model layer(s) may transform the embeddings into a probability distribution of tokens and feed the probability distribution to the sampling layer(s). The sampling layer(s) may select the next token from the probability distribution, for example, based on a random selection and/or any suitable sampling technique. The sampling layer(s) may feed the selected token to the input of the LLM. The head(s) may convert the probability distribution(s) into LLM generated content, such as text, image(s), video, and/or the like. As an example, the first LLM layer(s) 904a in the pipeline may be or include the embedding layers; the Nth LLM layer(s) 904n in the pipeline may be or include the sampling layer(s) and/or head(s); and the remaining or intermediate LLM layer(s) 904m in the pipeline may be or include the deep learning language model layer(s).

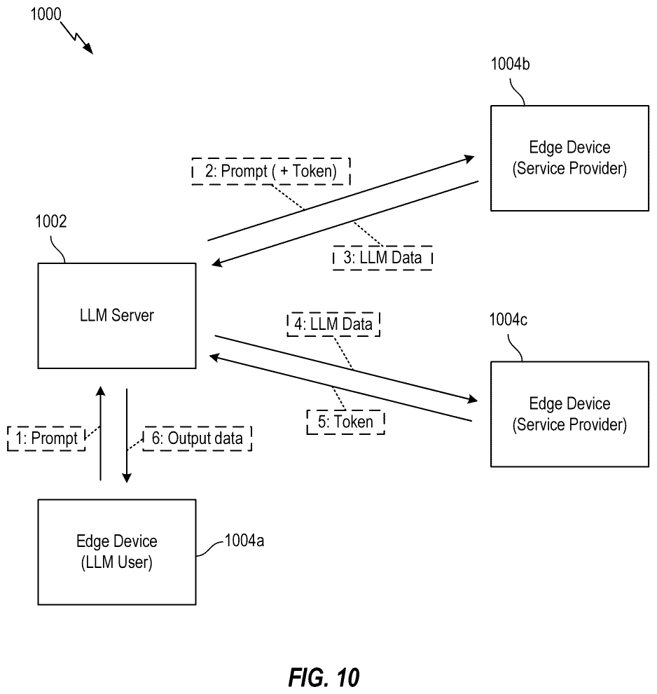

To enable distributed LLM processing, the LLM 902 may be segmented or divided into a plurality of segments including, for example, a first subset of LLM layers 910a and a second subset of LLM layers 910b. The first subset of LLM layers 910a and/or the second subset of LLM layers 910b may be deployed at or on one or more UEs or edge devices, for example, as further described herein with respect to FIG. 10. As an example, the first subset of LLM layers 910a may be deployed at a first UE (or edge device), and the second subset of LLM layers 910b may be deployed at a second UE (or edge device). The LLM processing may be distributed across the first UE and the second UE. In certain cases, the first subset of LLM layers 910a and/or the second subset of LLM layers 910a may be deployed at the same device and/or different devices. The output of the first subset of LLM layers may be fed to the second subset of LLM layers, which may generate the output data 908 and/or the next token for autoregressive inference. Each of the LLM segments may be a specific portion of the LLM in the processing pipeline or sequence of LLM layers.

Note that FIG. 9 depicts an example segmentation of the LLM to facilitate an understanding of distributed LLM processing. Aspects of the present disclosure may be applied to additional or alternative LLM segmentations, such as an LLM being divided into three or more segments and/or an LLM having multiple segmentations (for example, groups of segments). In certain cases, a segment or subset of an LLM may include any combination of embedding layer(s), deep learning language model layer(s), sampling layer(s), and/or head(s).

FIG. 10 depicts an example 1000 of distributed LLM processing via one or more edge devices (e.g., UE(s) and/or edge servers). In this example, an LLM server (hereinafter “the server 1002”) may be in communication with one or more edge devices, including, for example, a first edge device 1004a, a second edge device 1004b, and a third edge device 1004c. The server 1002 may be or include a model server (e.g., the model server 650 of FIG. 6) that manages distributed LLM processing tasks and/or deployment of LLM segment(s) at the edge device(s) 1004a-c. In certain cases, each of the edge devices 1004a-c may be or include a user edge device, such as a UE. In certain cases, the edge devices 1004a-c may include one or more user edge devices and/or one or more server edge devices. For example, the first edge device 1004a may be a UE, and the remaining edge device(s) 1004b, 1004c may be or include one or more network nodes deployed in a wireless communication system, such as a CU, DU, RU, core network (e.g., application function), an application server, and/or the like.

In certain cases, the server 1002 may be or include one or more cloud-based servers, for example, operated by an LLM service provider. The server 1002 may be accessible through a wireless communication system, such as a RAN and/or core network, via one or more backhaul links. As an example, the server 1002 may be in communication with the edge devices 1004a-c via a wireless communication system (e.g., network nodes and/or core network) through a public data network, a private data network, a hybrid data network, and/or IP services (e.g., the IP services 197), for example, as described herein with respect to FIGS. 1 and 2.

In certain cases, the server 1002 may be or include an edge server. As an example, the server 1002 may be integrated with or included in a network node, such as a CU, DU, RU, and/or core network. As an edge server, the server 1002 may be in communication with the edge devices 1004a-c via radio access links, fronthaul links, and/or midhaul links of the wireless communication system, for example, as described herein with respect to FIGS. 1 and 2.

In certain aspects, each of the edge devices 1004a-c may register as an LLM service provider and/or LLM user with the server 1002. The edge devices 1004a-c may send certain LLM service registration information to the server 1002. The LLM service registration information may indicate the role of the edge device, for example, as a client and/or LLM service provider. The LLM service registration information may indicate the capability of the edge device to perform distributed LLM processing. As an example, the first edge device 1004a may send, to the server 1002, an LLM service registration message that indicates the first edge device 1004a is an LLM user, which may indicate that the edge device can request LLM data to be processed based on a prompt.

As another example, each of the second edge device 1004b and the third edge device 1004c may send, to the server 1002, an LLM service registration message that indicates the respective edge device is an LLM service provider, which may indicate the edge device is capable of performing distributed LLM processing. In certain case, the LLM service registration message may indicate or include capability information associated with distributed LLM processing, as further described herein. The LLM service registration message or capability information may indicate the segment(s) of an LLM that is accessible for local computation of LLM data at the respective edge device. In certain aspects, the LLM registration message may include certain dynamic information, such as an indication of the computational resource(s) available for LLM processing, for example, as further described herein. Accordingly, the registration message may include certain static information (e.g., capability information) and/or dynamic information (e.g., computational resource usage and/or availability).

An LLM segment (or subset of LLM layers) being accessible for local computation of LLM data at a given edge device may refer to the edge device being capable of processing LLM data using the LLM segment. For example, the edge device may be equipped with specific hardware and/or software that supports storage of and running the LLM segment. As used herein, LLM data may include input data (e.g., the initial input data or prompt) fed to an LLM or an LLM segment, intermediate data fed to an LLM segment, and/or output data generated by the LLM or LLM segment. In certain cases, the input data may be pre-processed, for example, as described herein with respect to FIG. 7. An LLM segment may include a pre-processor, such as the pre-processor 704. In certain cases, the output data may be post-processed, for example, as described herein with respect to FIG. 7. An LLM segment may include a post-processor, such as the post-processor 726.

The capability information may indicate the LLM capabilities of the edge device. The capability information may indicate one or more local computational capabilities associated with distributed computation of LLM data. The capability information may include an indication of an LLM that includes the subset of pretrained LLM layers, such as an LLM function name (e.g., text-to-text transformation, text-to-image transformation, text-to-video transformation, code development, chatbot, and/or the like), an LLM identifier, or the like. The indication of the LLM may identify a specific LLM, such as Llama 3, T5, Gemma, BLOOM, or the like. The capability information may include an indication of a location or position of the subset of pretrained LLM layers in the LLM. For example, the capability information may indicate that the subset of LLM layers may start at the embedding layer, the tenth LLM layer of N total transformer layers (e.g., 32), the final dense layer (e.g., the head), or the like. The capability information may indicate the range of subset of LLM layers, for example, a total of 5 layers, a total of 10 layers, a total of 20 layers, layers 10-20 of 32 layers, or the like.

The capability information may indicate various characteristics associated with the LLM. The capability information may include an indication of a quantization level or technique associated with the subset of pretrained LLM layers, such as a quantization of 32-bit floating point to 16-bit floating point or 8-bit integer. The capability information may include an indication of a set of decoder parameters associated with the subset of pretrained LLM layers, such as beam searching or speculative decoding parameters.

The capability information may indicate the total computation capabilities and/or total memory capabilities of the edge device for LLM processing. The capability information may include an indication of a processing throughput associated with the subset of pretrained LLM layers, such as a batch size, tokens per second, a context length, and/or tera operations per second. The capability information may include an indication of a processing latency associated with the subset of pretrained LLM layers, such as an inference latency, total inference time, or the like. The capability information may include an indication of a total memory capacity associated with local computation of LLM data. For example, the total memory capacity may indicate or include the memory capacity of CPU RAM, GPU VRAM, high bandwidth memory (HBM), and/or the like.

With respect to the LLM segmentation depicted in FIG. 9, the second edge device 1004b may notify the server 1002 that the first subset of LLM layers 910a is deployed or deployable (e.g., supported for deployment) at the second edge device 1004b. The third edge device 1004c may notify the server 1002 that the second subset of LLM layers 910b is deployed or deployable at the third edge device 1004c. In certain aspects, the edge devices 1004a-c may notify the server 1002 of certain LLM processing capabilities, such as an expected processing latency to process LLM data through the respective LLM segment (e.g., via forward propagation through the subset of LLM layers) deployed at the edge device 1004a-c. In certain cases, the edge device(s) 1004a-c may notify the server 1002 of a price or cost to use the LLM processing of the respective edge device 1004a-c. In certain cases, the server 1002 may configure the edge device(s) 1004a-c to use certain LLM segment(s) for distributed LLM processing.

In certain cases, the server 1002 may notify the edge devices 1004a-c and/or any other devices (such as the network node(s) of the wireless communication system) that distributed LLM processing is available or enabled, for example, through the second edge device 1004b and/or the third edge device 1004c. The server 1002 may provide a web-based interface and/or an application programming interface (API) to access the distributed LLM processing.

The first edge device 1004a may send, to the server 1002, a request to perform distributed LLM processing. The request may include an expected processing throughput (e.g., token rate) and/or processing latency (e.g., inference time) of the distributed LLM processing. In certain cases, the request may include the price the LLM user is willing to pay for the distributed LLM processing (or acceptance of such a price). The request may include input data (such as a prompt) to provide to the LLM. The server 1002 may send, to the first edge device 1004a, an acknowledgment message indicating that the request is accepted for distributed LLM processing. In certain cases, the first edge device 1004a may send, to the server 1002, the input data after receiving the acknowledgment message.

The server 1002 may coordinate the distributed LLM processing of the input data across the second edge device 1004b and the third edge device 1004c. For example, the server 1002 may select and schedule the chain of LLM processing performed through the edge devices 1004b, 1004c. In certain aspects, the edge devices 1004b, 1004c may perform sequential forward propagation through the LLM layers hosted by the respective edge devices, such that the output data is generated via the overall LLM formed through LLM segments of the edge devices 1004b, 1004c. As an example, the server 1002 may send the prompt to the second edge device 1004b, which may generate intermediate LLM data based on the prompt. The second edge device 1004b may send, to the server, the intermediate LLM data; and the server 1002 may forward the intermediate LLM data to the third edge device 1004c, which may generate a token. The server 1002 may append the token to the prompt and send the next prompt to the second edge device 1004b, which may generate another instance of intermediate LLM data. The server 1002 may forward the other instance of intermediate LLM data to the third edge device 1004c, which may generate the output data. The server 1002 may forward the output data (for example, including one or more tokens) to the first edge device 1004a. In certain cases, the first edge device 1004a may perform pre-processing and/or a portion of the distributed LLM processing, such as processing of the input data via one or more embedding layers.

Before, during, and/or after the distributed LLM processing, the server 1002 may obtain, from the second edge device 1004b and/or the third edge device 1004c, status report(s) that indicate the availability and/or usage of one or more computational resources at the respective edge device 1004b, 1004c. As an example, a status report may include an indication of one or more computational resources being available, for local computation of LLM data, at a specific occasion (e.g., a past, current or future occasion in time). In certain aspects, indication of the computational resource(s) availability and/or usage may be or include a statistical value and/or instantaneous value (e.g., processor usage or memory usage). The statistical value may be or include an average value over a moving or running time window, a median value over the moving time window, a peak value over the moving time window, a minimum value over the moving time window, and/or the like. The instantaneous value may be or include a value measured or obtained at a specific instance of time.

The status report may include an indication of a total number of LLM tasks being or expected to be processed at the occasion. The status report may include an indication of a battery status at the occasion, such as a percent charged. The battery status may enable the server 1002 to determine whether to schedule tasks at the edge device, for example, depending on if the battery status is above a battery percentage threshold. In certain aspects, the status report may indicate or include the usage or availability of computational resource(s). The status report may indicate a memory capacity available and/or a memory usage at the occasion, such as the usage or availability of VRAM and/or HBM. The status report may indicate a processing throughput available and/or processing throughput usage at the occasion, for example, in terms of tera operations per second, tokens per second, and/or the like. The status report may indicate the processing latency, for example, as a total inference time or total processing latency.

The status report(s) may be communicated periodically, in response to requests from the server 1002, and/or in response to certain criteria being satisfied (e.g., when the usage of computational resources matches a threshold level). The processing (computation) usage, memory usage, and battery status of the edge device may change over time, for example, due to various processing tasks (e.g., inference, media applications, gaming applications, or the like) using the computational resources of the edge device. In certain cases, the status reporting may be periodic. The edge device may be configured to send a status report with a periodicity, for example, every 20 milliseconds (ms), 80 ms, 120 ms, 500 ms, or the like.

In certain cases, the status reporting may be aperiodic, and the edge device may be configured to send a status report in response to certain trigger event(s). For example, the edge device may be configured with an aperiodic status report, and upon receiving a request for the aperiodic status report (e.g., DCI indicating the specific status report), the edge device may send the aperiodic status report.

In certain cases, the status reporting may be initiated or triggered by the edge device. The edge device may send the status report independent of server activity. The edge device may send the status report when there are changes to the distributed LLM processing capability and/or computational resource availability of the edge device. As an example, the edge device may send the status report when an error is encountered while performing LLM inference. As another example, the edge device may send the status report when the deployed LLM segment is updated. As another example, the edge device may send the status report when the usage of computational resources is below, matches, is above a threshold level (e.g., below 10% and/or above 90%), changes by a threshold, etc.

In certain cases, the status reporting may be initialized or triggered by the server 1002. The edge device may send the status report in response to a request from the server 1002. The server 1002 may send a request to the edge device for the edge to device to provide an indication of the computational resources available for distributed LLM processing. Upon receiving the request, the edge device may send a status report to the server 1002.

The server 1002 may use the status report(s) to determine which LLM processing task(s) (if any) can be scheduled at a specific edge device. Communication of status report(s) and/or LLM processing capabilities (discussed above) may enable the server 1002 to reliably schedule the LLM processing tasks at the edge devices. For example, the status report(s) and/or LLM processing capabilities may enable the server to avoid overscheduling LLM processing tasks and/or scheduling incompatible LLM processing tasks (e.g., LLM processing tasks which may not be supported by an edge device) at edge devices. Accordingly, the reported information associated with distributed LLM processing may enable reduced latencies in processing LLM data and/or enable reliable and accurate LLM data generation.

Note that FIG. 10 depicts an example server-client architecture to facilitate an understanding of distributed LLM processing. Aspects of the present disclosure may be applied to other suitable distributed LLM processing architectures, such as peer-to-peer distributed processing architectures (e.g., where peer edge devices coordinate processing tasks independent of a centralized server), point-to-point network topologies (such as edge devices communicating with each other directly, such as exchanging LLM data), or the like.

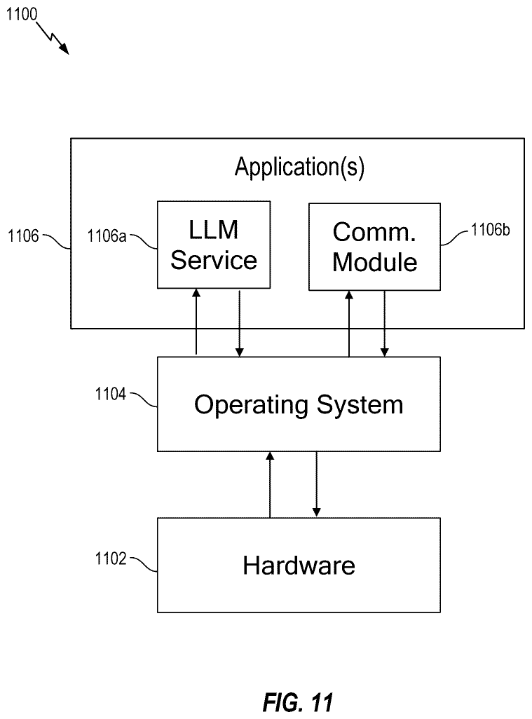

FIG. 11 depicts an example computer architecture 1100 of an edge device. In this example, the edge device may include hardware 1102, an operating system 1104, and application(s) 1106. The applications 1106 may include an LLM service 1106a, and in certain cases, a communication module 1106b. The applications 1106 may include other software, such as a video streaming application, a gaming application, a communication application (such as a video call or voice call application), and/or the like. The hardware may include a processing system, such as the processing system 316 of FIG. 3. As an example, the hardware 1102 may include one or more processors, one or more memories, and a power source including internal power source(s) (such as a battery and/or a power harvesting device) and/or external power source(s). In certain cases, the hardware 1102 may include computational resources that may be specialized to accelerate LLM processing, such as an AI processor, GPU, VRAM, HBM, and/or the like.

The operating system 1104 may be in communication with the hardware 1102 and the applications 1106. The operating system 1104 may manage the computational resources of the hardware 1102 for use by the applications 1106. Based on the operational status of the hardware 1102, the operating system 1104 may allocate hardware resources and schedule certain processing tasks requested by the applications, such as the LLM service 1106a and/or communication module 1106b.

The LLM service 1106a may be a program that performs LLM processing, such as distributed LLM processing. The LLM service 1106a may register as a host for distributed LLM processing with a model server, such as the server 1002 of FIG. 10. In certain cases, the LLM service 1106a may be or include a client that accesses distributed LLM processing resources, such as one or more edge devices, as described herein with respect to FIG. 10.

The communication module 1106b may be a program that enables wireless communications via one or more radio access links through one or more transceivers, such as the one or more transceivers 324. In certain cases, the communication module 1106b may be integrated with or be part of the operating system 1104. The communication module 1106b may implement the user plane and control plane protocol stacks described herein with respect to FIGS. 8A and 8B.

In certain aspects, the edge device may report capability information and/or status report(s) associated with distributed LLM processing. The reporting message(s) may be communicated through the user plane and/or control plane protocol stacks as described herein with respect to FIGS. 8A and 8B. For reporting through the user plane, the LLM service 1106a may generate a reporting message and send the reporting message via one or more IP packets. As discussed, the LLM service 1106a may provide, to a server, capability information associated with distributed LLM processing as a part of service registration with the server. The capability information may be sent via the user plane. The server may send a reporting configuration to the LLM service 1106a, for example, via the user plane. The reporting configuration may indicate to report status report(s) periodically, in response to request(s) from the server, and/or in response to certain criteria being satisfied (such as when the usage of computational resources matches a threshold level).

For reporting through the control plane, the edge device may send capability information and/or status reports via control signaling including, for example, RRC signaling, MAC signaling, UCI, and/or the like. The control plane may provide reliable and low latency signaling for communication of the status report(s) and/or capability information. As an example, the edge device may obtain a reporting configuration via RRC signaling, and the edge device may send periodic status report(s) via RRC signaling. As another example, the edge device may send UE initiated status report(s) and/or on-demand status report(s) - for example, server requested report(s)—via MAC signaling, such as a MAC control element (MAC-CE).

In certain aspects, the communication module 1106b and/or the LLM service 1106a may request for the information to be reported from the operating system 1104. The operating system 1104 may monitor the status of the hardware 1102 provide the operational status of certain hardware to the communication module 1106b and/or the LLM service 1106a. In certain cases, if the edge device is not directly connected to the server (for example, the server is on a cloud, and the UE connects to a network node, which routes the UE's reporting message to the server), the edge device may send the reporting messages via the user plane. If the edge device is directly connected to the server (for example, a network node hosts an edge model server), the edge device may send the reporting messages via the control plane. In certain cases, if the LLM service is not registered with the server, the edge device may send the reporting messages via the control plane. If the LLM service is registered with the server, the edge device may send the reporting via the user plane.

Note that the computer architecture depicted in FIG. 11 is an example to facilitate an understanding of the operating system 1104 providing status and/or capability information associated with distributed LLM processing. Aspects of the present disclosure may be applied to other suitable computer architectures.

Note that communication of the reporting via the control plane and user plane protocol stacks is an example. Aspects of the present disclosure may be applied to a service-based architecture in addition to or instead of the protocol stack architecture described herein.

### Example Signaling of Capability Reporting for Distributed Language Model Processing

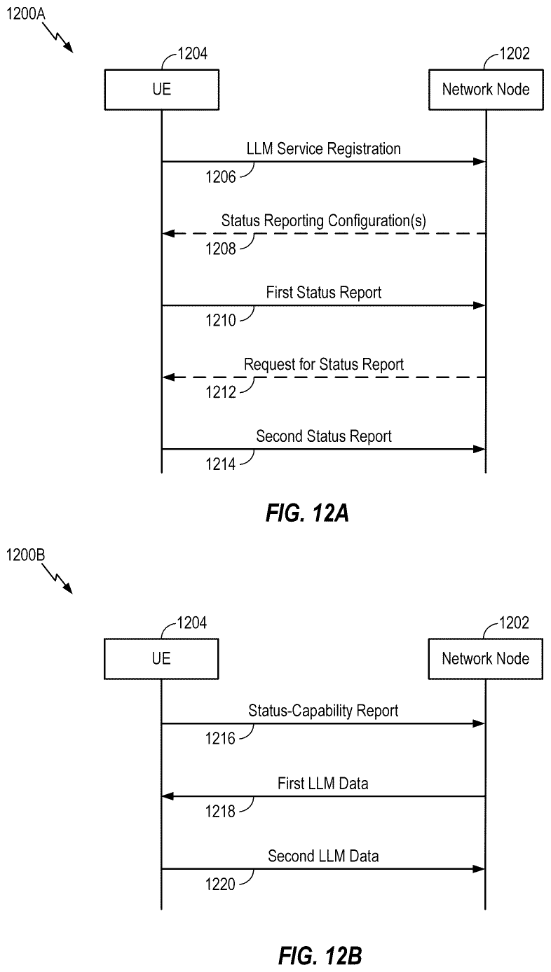

FIGS. 12A and 12B depict process flows 1200A, 1200B, respectively, for capability reporting for distributed language model processing in a system between a network node 1202 and a user equipment (UE) 1204. In some aspects, the network node 1202 may be an example of the BS 102 depicted and described with respect to FIG. 1, the first network entity 300 or the second network entity 302 depicted and described with respect to FIG. 3, or a disaggregated base station depicted and described with respect to FIG. 2. In certain aspects, the network node 1202 may be an example of the server 1002 of FIG. 10 or a network node that includes or hosts the server 1002 of FIG. 10. Similarly, the UE 1204 may be an example of UE 104 depicted and described with respect to FIG. 1 or the UE 304 depicted and described with respect to FIG. 3. In certain aspects, the UE 1204 may be an example of an edge device, such as the first edge device 1004a, the second edge device 1004b, and/or the third edge device 1004c of FIG. 10. However, in other aspects, UE 1204 may be another type of wireless communications device, and network node 1202 may be another type of network entity or network node, such as those described herein. Note that any operations or signaling illustrated with dashed lines may indicate that that operation or signaling is an optional or alternative example.

Referring to FIG. 12A, at 1206, UE 1204 sends, to the network node 1202, an LLM service registration message that indicates or includes capability information associated with distributed LLM processing. The capability information may indicate one or more local computational capabilities associated with distributed computation of LLM data. As an example, the capability information may include an indication of a subset of pretrained LLM layers (e.g., the first subset of LLM layers of FIG. 9) that is accessible for local computation of the LLM data. With respected to FIGS. 12A and 12B, the subset of pretrained LLM layers deployed at the UE 1204 may be referred to as “the LLM segment.” In certain cases, the UE 1204 may send the capability information independent of an LLM service message. The capability information may be communicated via user plane traffic and/or control plane traffic. The capability information may be communicated via RRC signaling, MAC signaling, UCI, and/or the like.

At 1208, the UE 1204 optionally obtains, from the network node 1202, one or more status reporting configurations. The status reporting configuration(s) may indicate the specific information to include in a status report, such as the computational resource usage properties (e.g., memory and/or processing usage). The status reporting configuration(s) may indicate certain trigger event(s) that trigger the UE 1204 to send the status report. The trigger event(s) may be or include the network node 1202 requesting a status report and/or other event(s) triggered at the UE 1204. The status reporting configuration(s) may be communicated via user plane traffic and/or control plane traffic. The status reporting configuration(s) may be communicated via RRC signaling, MAC signaling, DCI, system information, and/or the like.

At 1210, the UE 1204 sends, to the network node 1202, a first status report that includes an indication of one or more first computational resources (e.g., memory and/or processing resource(s)) available, for local computation of LLM data, at a first occasion. The first status report may indicate the availability and/or usage of one or more computational resources at the UE 1204, for example, as described herein with respect to FIG. 10. The first status report may be an instance of periodic reporting, for example, according to the status reporting configuration(s) obtained at 1208. The first status report may be an instance of UE-initialized reporting, for example, triggered based on certain criteria being satisfied at the UE 1204. The first status report may be communicated via user plane traffic and/or control plane traffic. The first status report may be communicated via RRC signaling, MAC signaling, UCI, and/or the like.

At 1212, the UE 1204 optionally obtains, from the network node 1202, a request for a status report. As an example, the request may be an aperiodic reporting trigger for network node-initialized reporting. The request may be communicated via user plane traffic and/or control plane traffic. The request may be communicated via RRC signaling, MAC signaling, DCI, system information, and/or the like.

At 1214, the UE 1204 sends, to the network node 1202, a second status report that includes an indication of one or more second computational resources available, for local computation of LLM data, at a second occasion that occurs after the first occasion. The second status report may indicate the availability and/or usage of one or more computational resources at the UE 1204, for example, as described herein with respect to FIG. 10. The second status report may be sent based on the UE 1204 receiving the request. The second status report may be communicated via user plane traffic and/or control plane traffic. The second status report may be communicated via RRC signaling, MAC signaling, UCI, and/or the like.

Referring to FIG. 12B, at 1216, the UE 1204 sends, to the network node 1202, a status-capability report that indicates the capability information and/or status information for distributed LLM processing as described herein. The status-capability report may include any of the capability information and/or status information described herein with respect to FIGS. 9-12A.

At 1218, the UE 1204 obtains, from the network node 1202, first LLM data for LLM processing. The network node 1202 may schedule the LLM processing of the first LLM data at the UE 1204 based on the capability-status report communicated at 1216. The UE 1204 may obtain, from the network node 1202, a request to process the first LLM data using the LLM segment, for example, as described herein with respect to FIGS. 9 and 10. The first LLM data may include input data (e.g., a prompt and/or one or more tokens), intermediate LLM data, and/or output data (e.g., one or more tokens), for example, as described herein with respect to FIG. 10. The UE 1204 may provide the first LLM data to the LLM segment, and the UE 1204 may obtain second LLM data from the LLM segment. The UE 1204 may generate the second LLM data using the LLM segment. The second LLM data may include intermediate LLM data and/or output data.

At 1220, the UE 1204 sends, to the network node 1202, the second LLM data, for example, generated at the UE 1204 as a part of distributed LLM processing. As described herein with respect to FIG. 10, the network node 1202 may forward the second LLM data to be processed at another UE or edge device, such as the third edge device 1004c of FIG. 10. In certain cases, the network node 1202 may forward the second LLM data to be used at an LLM user, such as the first edge device 1004a of FIG. 10.

Communication of the capability information and the status reports (for example, at 1206, 1210, and/or 1218) may enable the network node 1202 to reliably schedule the LLM processing tasks at the UE 1204. Communication of the capability information and/or the status reports may enable reduced latencies in processing LLM data and/or enable reliable and accurate LLM data to be generated.

Note that the process flows illustrated in FIGS. 12A and 12B is described herein to facilitate an understanding of capability reporting for distributed language model processing, and aspects of the present disclosure may be performed in various manners via alternative or additional signaling and/or operations. In certain aspects, the operations and/or signaling of FIGS. 12A and 12B may occur in an order different from that described or depicted, and various actions, operations, and/or signaling may be added, omitted, or combined.

### Example Operations of Capability Reporting for Distributed Language Model Processing

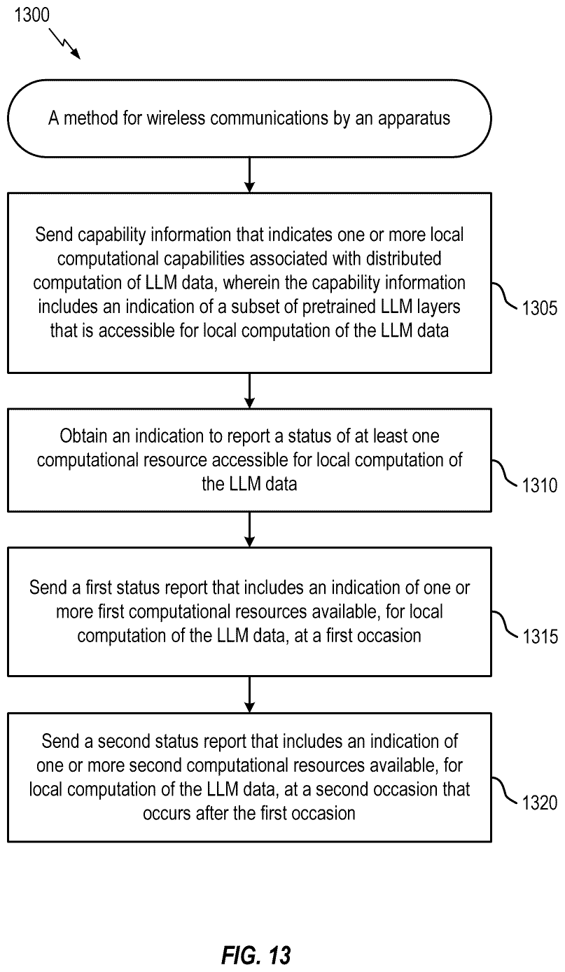

FIG. 13 shows a method 1300 for wireless communications by an apparatus, such as UE 104 of FIG. 1 or UE 304 of FIG. 3, and/or an edge device, such as the first edge device 1004a, the second edge device 1004b, and/or the third edge device 1004c of FIG. 10.

Method 1300 begins at block 1305 with sending capability information that indicates one or more local computational capabilities associated with distributed computation of LLM data, wherein the capability information includes an indication of a subset of pretrained LLM layers that is accessible for local computation of the LLM data, for example, as described herein with respect to FIGS. 9-12B.

Method 1300 then proceeds to block 1310 with obtaining an indication to report a status of at least one computational resource accessible for local computation of the LLM data, for example, as described herein with respect to FIGS. 9-12B.

Method 1300 then proceeds to block 1315 with sending a first status report that includes an indication of one or more first computational resources available, for local computation of the LLM data, at a first occasion, for example, as described herein with respect to FIGS. 9-12B.

Method 1300 then proceeds to block 1320 with sending a second status report that includes an indication of one or more second computational resources available, for local computation of the LLM data, at a second occasion that occurs after the first occasion, for example, as described herein with respect to FIGS. 9-12B.

In certain aspects, the capability information further includes one or more of: an indication of an LLM that includes the subset of pretrained LLM layers; an indication of a location of the subset of pretrained LLM layers in the LLM; an indication of a processing throughput associated with the subset of pretrained LLM layers; an indication of a processing latency associated with the subset of pretrained LLM layers; an indication of a total memory capacity associated with local computation of the LLM data; an indication of a quantization level associated with the subset of pretrained LLM layers; or an indication of a set of decoder parameters associated with the subset of pretrained LLM layers.

In certain aspects, the first status report further includes one or more of: an indication of a total number of LLM tasks processed at the first occasion; or an indication of a battery status at the first occasion.

In certain aspects, the indication of the one or more first computational resources includes one or more of: a memory capacity available at the first occasion; a processing throughput available at the first occasion; a memory usage at the first occasion; or a processing throughput usage at the first occasion.

In certain aspects, method 1300 further includes sending LLM service registration information that includes one or more of the capability information or the first status report.

In certain aspects, the indication to report the status of the at least one computational resource includes an indication to periodically report the status of the at least one computational resource; the first status report is a first periodic instance; and the second status report is a second periodic instance.

In certain aspects, the indication to report the status of the at least one computational resource includes an indication of one or more trigger events; and block 1315 includes sending the first status report based at least in part on the one or more trigger events being satisfied.

In certain aspects, block 1315 includes sending the first status report after obtaining the indication to report the status of the at least one computational resource.

In certain aspects, block 1315 includes sending the first status report via one or more of control plane traffic or user plane traffic.

In certain aspects, block 1315 includes sending the first status report via one or more of a radio resource control message, a medium access control message, or uplink control information.

In certain aspects, block 1315 includes sending the first status report via user plane traffic based at least in part on an LLM service not being connected to an LLM server (e.g., the server 1002 of FIG. 10).

In certain aspects, block 1315 includes sending the first status report via control plane traffic based at least in part on an LLM service being connected to an LLM server.

In certain aspects, method 1300 further includes obtaining first LLM data after sending the first status report. In certain aspects, method 1300 further includes providing, to the subset of pretrained LLM layers, input data that includes the first LLM data. In certain aspects, method 1300 further includes obtaining, from the subset of pretrained LLM layers, output data that includes second LLM data. In certain aspects, method 1300 further includes sending the second LLM data.

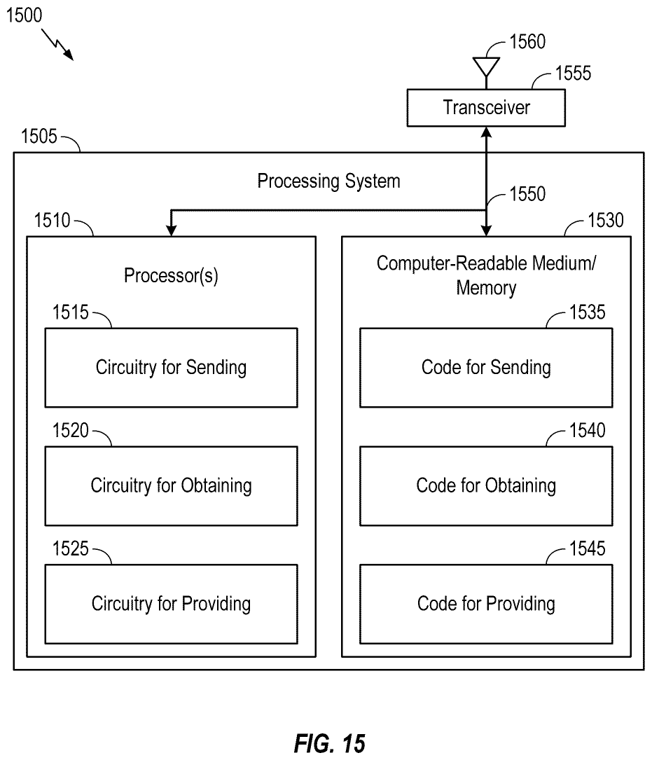

In certain aspects, method 1300, or any aspect related to it, may be performed by an apparatus, such as communications device 1500 of FIG. 15, which includes various components operable, configured, or adapted to perform the method 1300. Communications device 1500 is described below in further detail.

Note that FIG. 13 is just one example of a method, and other methods including fewer, additional, or alternative operations are possible consistent with this disclosure.

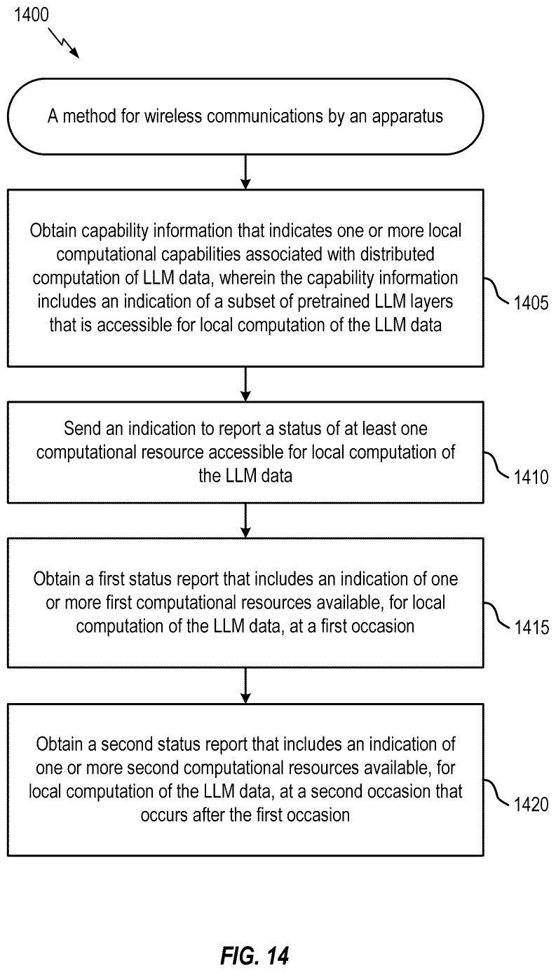

FIG. 14 shows a method 1400 for wireless communications by an apparatus, such as BS 102 of FIG. 1, a first network entity 300 or second network entity 302 of FIG. 3, or a disaggregated base station as discussed with respect to FIG. 2.

Method 1400 begins at block 1405 with obtaining capability information that indicates one or more local computational capabilities associated with distributed computation of LLM data, wherein the capability information includes an indication of a subset of pretrained LLM layers that is accessible for local computation of the LLM data, for example, as described herein with respect to FIGS. 9-12B.

Method 1400 then proceeds to block 1410 with sending an indication to report a status of at least one computational resource accessible for local computation of the LLM data, for example, as described herein with respect to FIGS. 9-12B.

Method 1400 then proceeds to block 1415 with obtaining a first status report that includes an indication of one or more first computational resources available, for local computation of the LLM data, at a first occasion, for example, as described herein with respect to FIGS. 9-12B.

Method 1400 then proceeds to block 1420 with obtaining a second status report that includes an indication of one or more second computational resources available, for local computation of the LLM data, at a second occasion that occurs after the first occasion, for example, as described herein with respect to FIGS. 9-12.

In certain aspects, the capability information further includes one or more of: an indication of an LLM that includes the subset of pretrained LLM layers; an indication of a location of the subset of pretrained LLM layers in the LLM; an indication of a processing throughput associated with the subset of pretrained LLM layers; an indication of a processing latency associated with the subset of pretrained LLM layers; an indication of a total memory capacity associated with local computation of the LLM data; an indication of a quantization level associated with the subset of pretrained LLM layers; or an indication of a set of decoder parameters associated with the subset of pretrained LLM layers.

In certain aspects, the first status report further includes one or more of: an indication of a total number of LLM tasks processed at the first occasion; or an indication of a battery status at the first occasion.

In certain aspects, the indication of the one or more first computational resources includes one or more of: a memory capacity available at the first occasion; a processing throughput available at the first occasion; a memory usage at the first occasion; or a processing throughput usage at the first occasion.

In certain aspects, method 1400 further includes obtaining LLM service registration information that includes one or more of the capability information or the first status report.

In certain aspects, the indication to report the status of the at least one computational resource includes an indication to periodically report the status of the at least one computational resource; the first status report is a first periodic instance; and the second status report is a second periodic instance.

In certain aspects, the indication to report the status of the at least one computational resource includes an indication of one or more trigger events; and block 1415 includes obtaining the first status report based at least in part on the one or more trigger events being satisfied.

In certain aspects, block 1415 includes obtaining the first status report after sending the indication to report the status of the at least one computational resource.

In certain aspects, block 1415 includes obtaining the first status report via one or more of control plane traffic or user plane traffic.

In certain aspects, block 1415 includes obtaining the first status report via one or more of a radio resource control message, a medium access control message, or uplink control information.

In certain aspects, block 1415 includes obtaining the first status report via user plane traffic based at least in part on an LLM service not being connected to an LLM server.

In certain aspects, block 1415 includes obtaining the first status report via control plane traffic based at least in part on an LLM service being connected to an LLM server.

In certain aspects, method 1400 further includes sending, to a first edge device, first LLM data after obtaining the first status report. In certain aspects, method 1400 further includes obtaining, from the first edge device (e.g., a UE and/or network node), second LLM data. In certain aspects, method 1400 further includes sending, to a second edge device, the second LLM data. In certain aspects, method 1400 further includes obtaining, from the second edge device, third LLM data. In certain aspects, method 1400 further includes sending, to a third edge device, the third LLM data.

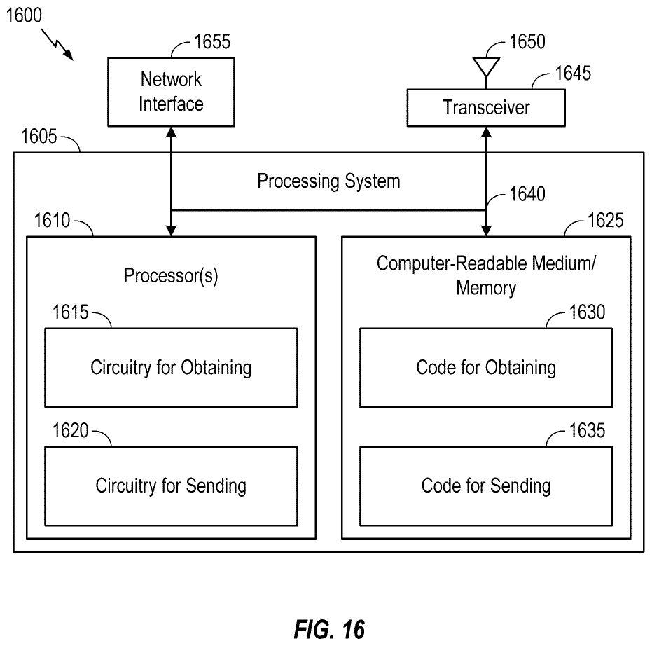

In certain aspects, method 1400, or any aspect related to it, may be performed by an apparatus, such as communications device 1600 of FIG. 16, which includes various components operable, configured, or adapted to perform the method 1400. Communications device 1600 is described below in further detail.

Note that FIG. 14 is just one example of a method, and other methods including fewer, additional, or alternative operations are possible consistent with this disclosure.

### Example Communications Devices

FIG. 15 depicts aspects of an example communications device 1500 configured for wireless communications. In certain aspects, communications device 1500 is a user equipment, such as UE 104 described above with respect to FIG. 1 or UE 304 described with respect to FIG. 3.

The communications device 1500 includes a processing system 1505 coupled to a transceiver 1555 (e.g., a transmitter and/or a receiver). The transceiver 1555 is configured to transmit and receive signals for the communications device 1500 via an antenna 1560, such as the various signals as described herein. The processing system 1505 may be configured to perform processing functions for the communications device 1500, including processing signals received and/or to be transmitted by the communications device 1500.

The processing system 1505 includes one or more processors 1510 and a computer-readable medium/memory 1530. In various aspects, the one or more processors 1510 may be representative of the one or more processors 318 described with respect to FIG. 3. The one or more processors 1510 are coupled to a computer-readable medium/memory 1530 via a bus 1550. In certain aspects, the computer-readable medium/memory 1530 may be representative of the one or more memories 320 described with respect to FIG. 3. The computer-readable medium/memory 1530 is a non-transitory computer-readable medium/memory. In certain aspects, the computer-readable medium/memory 1530 is configured to store instructions (e.g., computer-executable code), that when executed by the one or more processors 1510, cause the one or more processors 1510 to perform the method 1300 described with respect to FIG. 13, or any aspect related to it, including any operations described in relation to FIG. 13. Note that reference to a processor performing a function of communications device 1500 may include one or more processors performing that function of communications device 1500, such as in a distributed fashion.

In the depicted example, computer-readable medium/memory 1530 stores code (e.g., executable instructions), including code for sending 1535, code for obtaining 1540, and code for providing 1545. Processing of the code 1535-1545 may enable and cause the communications device 1500 to perform the method 1300 described with respect to FIG. 13, or any aspect related to it. For example, in certain aspects, code for sending 1535 includes code for sending capability information that indicates one or more local computational capabilities associated with distributed computation of large language model (LLM) data, wherein the capability information includes an indication of a subset of pretrained LLM layers that is accessible for local computation of the LLM data. In certain aspects, code for obtaining 1540 includes code for obtaining an indication to report a status of at least one computational resource accessible for local computation of the LLM data. In certain aspects, code for sending 1535 includes code for sending a first status report that includes an indication of one or more first computational resources available, for local computation of the LLM data, at a first occasion. In certain aspects, code for sending 1535 includes code for sending a second status report that includes an indication of one or more second computational resources available, for local computation of the LLM data, at a second occasion that occurs after the first occasion

The one or more processors 1510 include circuitry configured to implement (e.g., execute) the code stored in the computer-readable medium/memory 1530, including circuitry for sending 1515, circuitry for obtaining 1520, and circuitry for providing 1525. Processing with circuitry 1515-1525 may enable and cause the communications device 1500 to perform the method 1300 described with respect to FIG. 13, or any aspect related to it. For example, in certain aspects, circuitry for sending 1515 includes circuitry for sending capability information that indicates one or more local computational capabilities associated with distributed computation of large language model (LLM) data, wherein the capability information includes an indication of a subset of pretrained LLM layers that is accessible for local computation of the LLM data. In certain aspects, circuitry for obtaining 1520 includes circuitry for obtaining an indication to report a status of at least one computational resource accessible for local computation of the LLM data. In certain aspects, circuitry for sending 1515 includes circuitry for sending a first status report that includes an indication of one or more first computational resources available, for local computation of the LLM data, at a first occasion. In certain aspects, circuitry for sending 1515 includes circuitry for sending a second status report that includes an indication of one or more second computational resources available, for local computation of the LLM data, at a second occasion that occurs after the first occasion

More generally, means for communicating, transmitting, sending or outputting for transmission may include the one or more transceivers 324, one or more antenna 322 and/or processing system 316 of the UE 304 illustrated in FIG. 3, transceiver 1555 and/or antenna 1560 of the communications device 1500 in FIG. 15, and/or one or more processors 1510 of the communications device 1500 in FIG. 15. Means for communicating, receiving or obtaining may include the one or more transceivers 324, one or more antennas 322, and/or processing system 316 of the UE 304 illustrated in FIG. 3, transceiver 1555 and/or antenna 1560 of the communications device 1500 in FIG. 15, and/or one or more processors 1510 of the communications device 1500 in FIG. 15. For example, means for providing of the method 1300 described with respect to FIG. 13, or any aspect related to it, may include the processing system 316 of the UE 304 illustrated in FIG. 3, and/or one or more processors 1510 of the communications device 1500 in FIG. 15

FIG. 16 depicts aspects of an example communications device configured for wireless communications. In certain aspects, communications device 1600 is a network entity, such as BS 102 of FIG. 1, first network entity 300 or second network entity 302 of FIG. 3, or a disaggregated base station as discussed with respect to FIG. 2.

The communications device 1600 includes a processing system 1605 coupled to a transceiver 1645 (e.g., a transmitter and/or a receiver) and/or a network interface 1655. The transceiver 1645 is configured to transmit and receive signals for the communications device 1600 via an antenna 1650, such as the various signals as described herein. The network interface 1655 is configured to obtain and send signals for the communications device 1600 via communications link(s), such as a backhaul link, midhaul link, and/or fronthaul link as described herein, such as with respect to FIG. 2. The processing system 1605 may be configured to perform processing functions for the communications device 1600, including processing signals received and/or to be transmitted by the communications device 1600.

The processing system 1605 includes one or more processors 1610 and a computer-readable medium/memory 1625. In various aspects, one or more processors 1610 may be representative of the one or more processors 308, as described with respect to FIG. 3. The one or more processors 1610 are coupled to the computer-readable medium/memory 1625 via a bus 1640. In certain aspects, the computer-readable medium/memory 1625 is configured to store instructions (e.g., computer-executable code), including code 1630 and 1635, that when executed by the one or more processors 1610, cause the one or more processors 1610 to perform the method 1400 described with respect to FIG. 14, or any aspect related to it, including any operations described in relation to FIG. 14. The computer-readable medium/memory 1625 is a non-transitory computer-readable medium/memory. Note that reference to a processor of communications device 1600 performing a function may include one or more processors of communications device 1600 performing that function, such as in a distributed fashion.

In the depicted example, the computer-readable medium/memory 1625 stores code (e.g., executable instructions), including code for obtaining 1630 and code for sending 1635. Processing of the code 1630 and 1635 may enable and cause the communications device 1600 to perform the method 1400 described with respect to FIG. 14, or any aspect related to it. For example, in certain aspects, code for obtaining 1630 includes code for obtaining capability information that indicates one or more local computational capabilities associated with distributed computation of large language model (LLM) data, wherein the capability information includes an indication of a subset of pretrained LLM layers that is accessible for local computation of the LLM data. In certain aspects, code for sending 1635 includes code for sending an indication to report a status of at least one computational resource accessible for local computation of the LLM data. In certain aspects, code for obtaining 1630 includes code for obtaining a first status report that includes an indication of one or more first computational resources available, for local computation of the LLM data, at a first occasion. In certain aspects, code for obtaining 1630 includes code for obtaining a second status report that includes an indication of one or more second computational resources available, for local computation of the LLM data, at a second occasion that occurs after the first occasion.

The one or more processors 1610 include circuitry configured to implement (e.g., execute) the code stored in the computer-readable medium/memory 1625, including circuitry for obtaining 1615 and circuitry for sending 1620. Processing with circuitry 1615 and 1620 may enable and cause the communications device 1600 to perform the method 1400 described with respect to FIG. 14, or any aspect related to it. For example, in certain aspects, circuitry for obtaining 1615 includes circuitry for obtaining capability information that indicates one or more local computational capabilities associated with distributed computation of large language model (LLM) data, wherein the capability information includes an indication of a subset of pretrained LLM layers that is accessible for local computation of the LLM data. In certain aspects, circuitry for sending 1620 includes circuitry for sending an indication to report a status of at least one computational resource accessible for local computation of the LLM data. In certain aspects, circuitry for obtaining 1615 includes circuitry for obtaining a first status report that includes an indication of one or more first computational resources available, for local computation of the LLM data, at a first occasion. In certain aspects, circuitry for obtaining 1615 includes circuitry for obtaining a second status report that includes an indication of one or more second computational resources available, for local computation of the LLM data, at a second occasion that occurs after the first occasion.

Various components of the communications device 1600 may provide means for performing the method 1400 described with respect to FIG. 14, or any aspect related to it. Means for communicating, transmitting, sending or outputting for transmission may include the one or more transceivers 312, one or more antennas 314, and/or processing system 306 of the first network entity 300 or the second network entity 302 illustrated in FIG. 3, transceiver 1645, antenna 1650, and/or network interface 1655 of the communications device 1600 in FIG. 16, and/or one or more processors 1610 of the communications device 1600 in FIG. 16. Means for communicating, receiving or obtaining may include the one or more transceivers 312, one or more antennas 314, and/or processing system 306 of the first network entity 300 or the second network entity 302 illustrated in FIG. 3, transceiver 1645, antenna 1650, and/or network interface 1655 of the communications device 1600 in FIG. 16, and/or one or more processors 1610 of the communications device 1600 in FIG. 16.

### Example Clauses

Implementation examples are described in the following numbered clauses:
Clause 1: A method for wireless communications by an apparatus comprising: sending capability information that indicates one or more local computational capabilities associated with distributed computation of LLM data, wherein the capability information includes an indication of a subset of pretrained LLM layers that is accessible for local computation of the LLM data; obtaining an indication to report a status of at least one computational resource accessible for local computation of the LLM data; sending a first status report that includes an indication of one or more first computational resources available, for local computation of the LLM data, at a first occasion; and sending a second status report that includes an indication of one or more second computational resources available, for local computation of the LLM data, at a second occasion that occurs after the first occasion.
Clause 2: The method of Clause 1, wherein the capability information further includes one or more of: an indication of an LLM that includes the subset of pretrained LLM layers; an indication of a location of the subset of pretrained LLM layers in the LLM; an indication of a processing throughput associated with the subset of pretrained LLM layers; an indication of a processing latency associated with the subset of pretrained LLM layers; an indication of a total memory capacity associated with local computation of the LLM data; an indication of a quantization level associated with the subset of pretrained LLM layers; or an indication of a set of decoder parameters associated with the subset of pretrained LLM layers.
Clause 3: The method of any one of Clauses 1-2, wherein the first status report further includes one or more of: an indication of a total number of LLM tasks processed at the first occasion; or an indication of a battery status at the first occasion.
Clause 4: The method of any one of Clauses 1-3, wherein the indication of the one or more first computational resources includes one or more of: a memory capacity available at the first occasion; a processing throughput available at the first occasion; a memory usage at the first occasion; or a processing throughput usage at the first occasion.
Clause 5: The method of any one of Clauses 1-4, further comprising sending LLM service registration information that includes one or more of the capability information or the first status report.
Clause 6: The method of any one of Clauses 1-5, wherein: the indication to report the status of the at least one computational resource includes an indication to periodically report the status of the at least one computational resource; the first status report is a first periodic instance; and the second status report is a second periodic instance.
Clause 7: The method of any one of Clauses 1-6, wherein: the indication to report the status of the at least one computational resource includes an indication of one or more trigger events; and sending the first status report comprises sending the first status report based at least in part on the one or more trigger events being satisfied.
Clause 8: The method of any one of Clauses 1-7, wherein sending the first status report comprises sending the first status report after obtaining the indication to report the status of the at least one computational resource.
Clause 9: The method of any one of Clauses 1-8, wherein sending the first status report comprises sending the first status report via one or more of control plane traffic or user plane traffic.
Clause 10: The method of any one of Clauses 1-9, wherein sending the first status report comprises sending the first status report via one or more of a radio resource control message, a medium access control message, or uplink control information.
Clause 11: The method of any one of Clauses 1-10, wherein sending the first status report comprises sending the first status report via user plane traffic based at least in part on an LLM service not being connected to an LLM server.
Clause 12: The method of any one of Clauses 1-11, wherein sending the first status report comprises sending the first status report via control plane traffic based at least in part on an LLM service being connected to an LLM server.
Clause 13: The method of any one of Clauses 1-12, further comprising:
   obtaining first LLM data after sending the first status report; providing, to the subset of pretrained LLM layers, input data that includes the first LLM data; obtaining, from the subset of pretrained LLM layers, output data that includes second LLM data; and sending the second LLM data.
Clause 14: A method for wireless communications by a network node comprising: obtaining capability information that indicates one or more local computational capabilities associated with distributed computation of LLM data, wherein the capability information includes an indication of a subset of pretrained LLM layers that is accessible for local computation of the LLM data; sending an indication to report a status of at least one computational resource accessible for local computation of the LLM data; obtaining a first status report that includes an indication of one or more first computational resources available, for local computation of the LLM data, at a first occasion; and obtaining a second status report that includes an indication of one or more second computational resources available, for local computation of the LLM data, at a second occasion that occurs after the first occasion.
Clause 15: The method of Clause 14, wherein the capability information further includes one or more of: an indication of an LLM that includes the subset of pretrained LLM layers; an indication of a location of the subset of pretrained LLM layers in the LLM; an indication of a processing throughput associated with the subset of pretrained LLM layers; an indication of a processing latency associated with the subset of pretrained LLM layers; an indication of a total memory capacity associated with local computation of the LLM data; an indication of a quantization level associated with the subset of pretrained LLM layers; or an indication of a set of decoder parameters associated with the subset of pretrained LLM layers.
Clause 16: The method of any one of Clauses 14-15, wherein the first status report further includes one or more of: an indication of a total number of LLM tasks processed at the first occasion; or an indication of a battery status at the first occasion.
Clause 17: The method of any one of Clauses 14-16, wherein the indication of the one or more first computational resources includes one or more of: a memory capacity available at the first occasion; a processing throughput available at the first occasion; a memory usage at the first occasion; or a processing throughput usage at the first occasion.
Clause 18: The method of any one of Clauses 14-17, further comprising obtaining LLM service registration information that includes one or more of the capability information or the first status report.
Clause 19: The method of any one of Clauses 14-18, wherein: the indication to report the status of the at least one computational resource includes an indication to periodically report the status of the at least one computational resource; the first status report is a first periodic instance; and the second status report is a second periodic instance.
Clause 20: The method of any one of Clauses 14-19, wherein: the indication to report the status of the at least one computational resource includes an indication of one or more trigger events; and obtaining the first status report comprises obtaining the first status report based at least in part on the one or more trigger events being satisfied.
Clause 21: The method of any one of Clauses 14-20, wherein obtaining the first status report comprises obtaining the first status report after sending the indication to report the status of the at least one computational resource.
Clause 22: The method of any one of Clauses 14-21, wherein obtaining the first status report comprises obtaining the first status report via one or more of control plane traffic or user plane traffic.
Clause 23: The method of any one of Clauses 14-22, wherein obtaining the first status report comprises obtaining the first status report via one or more of a radio resource control message, a medium access control message, or uplink control information.
Clause 24: The method of any one of Clauses 14-23, wherein obtaining the first status report comprises obtaining the first status report via user plane traffic based at least in part on an LLM service not being connected to an LLM server.
Clause 25: The method of any one of Clauses 14-24, wherein obtaining the first status report comprises obtaining the first status report via control plane traffic based at least in part on an LLM service being connected to an LLM server.
Clause 26: The method of any one of Clauses 14-25, further comprising: sending, to a first edge device, first LLM data after obtaining the first status report; obtaining, from the first edge device, second LLM data; sending, to a second edge device, the second LLM data; obtaining, from the second UE, third LLM data; and sending, to a third edge device, the third LLM data.
Clause 27: One or more apparatuses, comprising: one or more memories comprising executable instructions; and one or more processors configured to execute the executable instructions and cause the one or more apparatuses to perform a method in accordance with any one of Clauses 1-26.
Clause 28: One or more apparatuses configured for wireless communications, comprising: one or more memories; and one or more processors, coupled to the one or more memories, configured to cause the one or more apparatuses to perform a method in accordance with any one of Clauses 1-26.
Clause 29: One or more apparatuses configured for wireless communications, comprising: one or more memories; and one or more processors, coupled to the one or more memories, configured to perform a method in accordance with any one of Clauses 1-26.
Clause 30: One or more apparatuses, comprising means for performing a method in accordance with any one of Clauses 1-26.
Clause 31: One or more non-transitory computer-readable media comprising executable instructions that, when executed by one or more processors of one or more apparatuses, cause the one or more apparatuses to perform a method in accordance with any one of Clauses 1-26.
Clause 32: One or more computer program products embodied on one or more computer-readable storage media comprising code for performing a method in accordance with any one of Clauses 1-26.
Clause 33: One or more apparatuses configured for wireless communications, comprising: a processing system that includes one or more processors and one or more memories coupled with the one or more processors, the processing system configured to cause the one or more apparatuses to perform a method in accordance with any one of Clauses 1-26.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, an AI processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a SoC, a SiP, or any other such configuration.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

As used herein, “coupled to” and “coupled with” generally encompass direct coupling and indirect coupling (e.g., including intermediary coupled aspects) unless stated otherwise. For example, stating that a processor is coupled to a memory allows for a direct coupling or a coupling via an intermediary aspect, such as a bus.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an ASIC, or processor.

The following claims are not intended to be limited to the aspects shown herein, but are to be accorded the full scope consistent with the language of the claims. Reference to an element in the singular is not intended to mean only one unless specifically so stated, but rather “one or more.” The subsequent use of a definite article (e.g., “the” or “said”) with an element (e.g., “the processor”) is not intended to invoke a singular meaning (e.g., “only one”) on the element unless otherwise specifically stated. For example, reference to an element (e.g., “a processor,” “the processor,” etc.), unless otherwise specifically stated, should be understood to refer to one or more elements (e.g., “one or more processors,” or the like). The terms “set” and “group” are intended to include one or more elements, and may be used interchangeably with “one or more.” Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions. Unless specifically stated otherwise, the term “some” refers to one or more. All structural and functional equivalents to the elements of the various aspects described throughout this disclosure that are known or later come to be known to those of ordinary skill in the art are intended to be encompassed by the claims. Moreover, nothing disclosed herein is intended to be dedicated to the public regardless of whether such disclosure is explicitly recited in the claims.

What is claimed is:

1. An apparatus for wireless communications, comprising a processing system that includes one or more processors and one or more memories coupled with the one or more processors, the processing system configured to cause the apparatus to:
send capability information that indicates one or more local computational capabilities associated with distributed computation of large language model (LLM) data, wherein the capability information includes an indication of a subset of pretrained LLM layers that is accessible for local computation of the LLM data;
obtain an indication to report a status of at least one computational resource accessible for local computation of the LLM data;
send a first status report that includes an indication of one or more first computational resources available, for local computation of the LLM data, at a first occasion; and
send a second status report that includes an indication of one or more second computational resources available, for local computation of the LLM data, at a second occasion that occurs after the first occasion.

2. The apparatus of claim 1, wherein the capability information further includes one or more of:
an indication of an LLM that includes the subset of pretrained LLM layers;
an indication of a location of the subset of pretrained LLM layers in the LLM;
an indication of a processing throughput associated with the subset of pretrained LLM layers;
an indication of a processing latency associated with the subset of pretrained LLM layers;
an indication of a total memory capacity associated with local computation of the LLM data;
an indication of a quantization level associated with the subset of pretrained LLM layers; or
an indication of a set of decoder parameters associated with the subset of pretrained LLM layers.

3. The apparatus of claim 1, wherein the first status report further includes one or more of:
an indication of a total number of LLM tasks processed at the first occasion; or
an indication of a battery status at the first occasion.

4. The apparatus of claim 1, wherein the indication of the one or more first computational resources includes one or more of:
a memory capacity available at the first occasion;
a processing throughput available at the first occasion;
a memory usage at the first occasion; or
a processing throughput usage at the first occasion.

5. The apparatus of claim 1, wherein the processing system is configured to cause the apparatus to send LLM service registration information that includes one or more of the capability information or the first status report.

6. The apparatus of claim 1, wherein:
the indication to report the status of the at least one computational resource includes an indication to periodically report the status of the at least one computational resource;
the first status report is a first periodic instance; and
the second status report is a second periodic instance.

7. The apparatus of claim 1, wherein:
the indication to report the status of the at least one computational resource includes an indication of one or more trigger events; and
to cause the apparatus to send the first status report, the processing system is configured to cause the apparatus to send the first status report based at least in part on the one or more trigger events being satisfied.

8. The apparatus of claim 1, wherein to cause the apparatus to send the first status report, the processing system is configured to cause the apparatus to send the first status report after obtaining the indication to report the status of the at least one computational resource.

9. The apparatus of claim 1, wherein to cause the apparatus to send the first status report, the processing system is configured to cause the apparatus to send the first status report via one or more of control plane traffic or user plane traffic.

10. The apparatus of claim 1, wherein to cause the apparatus to send the first status report, the processing system is configured to cause the apparatus to send the first status report via one or more of a radio resource control message, a medium access control message, or uplink control information.

11. The apparatus of claim 1, wherein to cause the apparatus to send the first status report, the processing system is configured to cause the apparatus to send the first status report via user plane traffic based at least in part on an LLM service not being connected to an LLM server.

12. The apparatus of claim 1, wherein to cause the apparatus to send the first status report, the processing system is configured to cause the apparatus to send the first status report via control plane traffic based at least in part on an LLM service being connected to an LLM server.

13. The apparatus of claim 1, wherein the processing system is configured to cause the apparatus to:
obtain first LLM data after sending the first status report;
provide, to the subset of pretrained LLM layers, input data that includes the first LLM data;
obtain, from the subset of pretrained LLM layers, output data that includes second LLM data; and
send the second LLM data.

14. An apparatus for wireless communications, comprising a processing system that includes one or more processors and one or more memories coupled with the one or more processors, the processing system configured to cause a network node to:
obtain capability information that indicates one or more local computational capabilities associated with distributed computation of large language model (LLM) data, wherein the capability information includes an indication of a subset of pretrained LLM layers that is accessible for local computation of the LLM data;
send an indication to report a status of at least one computational resource accessible for local computation of the LLM data;
obtain a first status report that includes an indication of one or more first computational resources available, for local computation of the LLM data, at a first occasion; and
obtain a second status report that includes an indication of one or more second computational resources available, for local computation of the LLM data, at a second occasion that occurs after the first occasion.

15. The apparatus of claim 14, wherein the capability information further includes one or more of:
an indication of an LLM that includes the subset of pretrained LLM layers;
an indication of a location of the subset of pretrained LLM layers in the LLM;
an indication of a processing throughput associated with the subset of pretrained LLM layers;
an indication of a processing latency associated with the subset of pretrained LLM layers;
an indication of a total memory capacity associated with local computation of the LLM data;
an indication of a quantization level associated with the subset of pretrained LLM layers; or
an indication of a set of decoder parameters associated with the subset of pretrained LLM layers.

16. The apparatus of claim 14, wherein the first status report further includes one or more of:
an indication of a total number of LLM tasks processed at the first occasion; or
an indication of a battery status at the first occasion.

17. The apparatus of claim 14, wherein the indication of the one or more first computational resources includes one or more of:
a memory capacity available at the first occasion;
a processing throughput available at the first occasion;
a memory usage at the first occasion; or
a processing throughput usage at the first occasion.

18. The apparatus of claim 14, wherein the processing system is configured to cause the network node to obtain LLM service registration information that includes one or more of the capability information or the first status report.

19. The apparatus of claim 14, wherein:
the indication to report the status of the at least one computational resource includes an indication to periodically report the status of the at least one computational resource;
the first status report is a first periodic instance; and
the second status report is a second periodic instance.

20. A method for wireless communications by an apparatus comprising:
sending capability information that indicates one or more local computational capabilities associated with distributed computation of large language model (LLM) data, wherein the capability information includes an indication of a subset of pretrained LLM layers that is accessible for local computation of the LLM data;
obtaining an indication to report a status of at least one computational resource accessible for local computation of the LLM data;
sending a first status report that includes an indication of one or more first computational resources available, for local computation of the LLM data, at a first occasion; and
sending a second status report that includes an indication of one or more second computational resources available, for local computation of the LLM data, at a second occasion that occurs after the first occasion.
